(19) United States
(12) Patent Application Publication
(10) Pub. No.: US 2003/0215095 A1
(43) Pub. Date: Nov. 20, 2003

(54) Time shift outputting method and time shift outputting apparatus for contents data

(75) Inventor: Nobuyuki Nagafuji, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/437,811

(22) Filed: May 14, 2003

(30) Foreign Application Priority Data
May 16, 2002 (JP) 2002-142194

(51) Int. Cl. H04L 9/00

(52) U.S. Cl. 380/277

(57) ABSTRACT

A time shift outputting method and a time shift outputting apparatus are disclosed by which temporarily stored contents are invalidated and disabled from further utilization after the temporary storage thereof. The time shift outputting apparatus includes a random number generator for outputting a random number value which varies as time passes, a delay flip-flop for retaining the random number value at an arbitral timing, an exclusive OR gate for changing a master encryption key signaled from a master encryption key transmission section using the random number value retained by the delay flip-flop to produce a work encryption key, an encryption section for encrypting data of contents using the work encryption key to produce encrypted data, a storage/reproduction transfer section for storing the encrypted data into a storage apparatus and reading out the stored encrypted data when predetermined time passes after the encrypted data is stored, an decoding section for decoding the encrypted data read out from the storage apparatus using the work encryption key, and a control section for causing the delay flip-flop to cancel the retention of the random number value after the encrypted data of the contents is decrypted.

### BACKGROUND OF THE INVENTION

1. Field of the Invention

The present invention relates to a time shift outputting method and a time shift outputting apparatus for outputting contents data stored in a storage medium in a time-shifted relationship, and more particularly to a time shift outputting method and a time shift outputting apparatus which disable utilization of contents data stored in a storage medium after the contents data are outputted in a time-shifted relationship.

2. Description of the Related Art

In recent years, in the field of satellite broadcasting for which a broadcasting satellite (BS) or a communication satellite (CS) is used, cable television (CATV) broadcasting and ground wave broadcasting, “digitization of broadcasting” which broadcasts a video signal and an audio signal in the form of digitally compressed codes has been and is proceeding in a world-wide scale.

Also in Japan, digital broadcasting services for which a communication satellite or a broadcasting satellite is used have been started, and preparations for starting of ground wave digital broadcasting services have been and are proceeding steadily.

In the situation described, processing of pictures and images as digital data is increasing also in audio-visual appliances.

Where a recording and/or reproduction apparatus for recording and/or reproducing images and sound is taken as an example, analog recording is conventionally used as represented by a VHS video recorder which magnetically records images and sound in the form of analog data.

In recent years, however, popularization also of recording and/or reproduction apparatus of the digital recording type which record data of images and/or sound digitally onto a magnetic recording medium or an optical recording medium as represented by a D-VHS recorder, a DVD recorder or a hard disk recorder have begun.

One of characteristics of the digital recording system is that data recorded on a recording medium exhibits little aged deterioration. While this is an advantage, it gives rise also to a problem that data duplicated from an original is recorded onto a recording medium without suffering from aged deterioration.

Therefore, as digitization of a recording apparatus proceeds, it becomes necessary to take a sufficient countermeasure for the protection of the copyright such as prevention of illegal copying.

For example, as regards the operation rules for BS/wide area CS digital broadcasting in Japan, it is investigated to include prescriptions for the protection of the copyright in the TR-B15 of the ARIB (Association of Radio Industries and Businesses) standards, and it is planned to incorporate prescriptions regarding storage limitation, temporary storage limitation and so forth by copy control of program contents.

The temporary storage signifies to digitally record data of contents temporarily onto a recording medium in order to perform “time shift reproduction” wherein stream data is stored first and then reproduced after a shift (delay) of predetermined time after it is stored.

For the standardization of the TR-B15 mentioned above, it is investigated to incorporate it as a requirement for the temporary storage that, although temporary storage of contents whose copying is inhibited is permitted, the contents are invalidated and disabled from further utilization after the temporary storage.

### SUMMARY OF THE INVENTION

It is an object of the present invention to provide a time shift outputting method and a time shift outputting apparatus by which temporarily stored contents are invalidated and disabled from further utilization after the temporary storage thereof.

In order to attain the object described above, according to a first aspect of the present invention, there is provided a time shift outputting method comprising a key retaining step of retaining an encryption key, which varies as time passes, at an arbitrary timing, a step of encrypting data of contents using the encryption key retained at the key retaining step to produce encrypted data, a step of storing the encrypted data into storage means, a readout step of reading out the encrypted data stored in the storage means when predetermined time passes after the encrypted data is stored, a step of decrypting the encrypted data read out at the readout step using the encryption key retained at the key retaining step, and a step of canceling the retention of the encryption key after the decryption of the encrypted data of the contents ends.

In the time shift outputting method according to the first aspect, preferably the retention of the encryption key is canceled when predetermined time passes after the storage of the encrypted data of the contents into the storage means is started. Alternatively, the retention of the encryption key may be canceled when predetermined time passes after the storage of the encrypted data of the contents into the storage means ends. Preferably, at least part of the encryption key varies as time passes.

According to a second aspect of the present invention, there is provided a time shift outputting method comprising a random number retaining step of retaining a random number value, which varies as time passes, at an arbitrary timing, a step of changing a master encryption key using the random number value retained at the random number retaining step to produce a work encryption key, a step of encrypting data of contents using the work encryption key to produce encrypted data, a step of storing the encrypted data into storage means, a readout step of reading out the encrypted data stored in the storage means when predetermined time passes after the encrypted data is stored, a step of decrypting the encrypted data read out at the readout step using the work encryption key, and a step of canceling the retention of the random number value after the decryption of the encrypted data of the contents ends.

According to a third aspect of the present invention, there is provided a time shift outputting method comprising a random number retaining step of retaining a random number value, which varies as time passes, at an arbitrary timing a step of changing a master encryption key using the random number value retained at the random number retaining step to produce an encryption key, a step of encrypting data of contents using the encryption key to produce encrypted data, a step of storing the encrypted data into storage means, a readout step of reading out the encrypted data stored in the storage means when predetermined time passes after the encrypted data is stored, a step of changing the master encryption key using the random number value retained at the random number retaining step to produce a decryption key, a step of decrypting the encrypted data read out at the readout step using the decryption key, and a step of canceling the retention of the random number value retained at the random number retaining step after the decryption of the encrypted data of the contents ends.

According to a fourth aspect of the present invention, there is provided a time shift outputting method comprising a random number retaining step of retaining a random number value, which varies as time passes, at an arbitrary timing, a step of encoding data of contents using the random number value retained at the random number retaining step to produce encrypted data, a step of storing the encrypted data into storage means, a readout step of reading out the encrypted data stored in the storage means when predetermined time passes after the encrypted data is stored, a step of decrypting the encrypted data read out at the readout step using the random number value retained at the random number retaining step, and a step of canceling the retention of the random number value retained at the random number retaining step after the decryption of the encrypted data of the contents ends.

According to a fifth aspect of the present invention, there is provided a time shift outputting method comprising a random number retaining step of retaining a random number value, which varies as time passes, at an arbitrary timing, a step of calculating the random number value retained at the random number retaining step with a one-way function by a predetermined number of times to produce an initial random number value, a step of calculating the initial random number value with the one-way function by the predetermined number of times to produce an encrypting random number value, a step of changing a master encryption key using the encrypting random number value to produce an encryption key, a step of encrypting data of contents using the encryption key to produce encrypted data, a step of storing the encrypted data into storage means, a readout step of reading out the encrypted data stored in the storage means when predetermined time passes after the encrypted data is stored, a step of calculating the initial random number value with the one-way function by the predetermined number of times to produce a decrypting random number value, a step of changing the master encryption key using the decrypting random number value to produce a decryption key, a step of decrypting the encrypted data read out at the readout step using the decryption key, and a step of canceling the retention of the random number value retained at the random number retaining step after the decryption of the encrypted data of the contents ends.

In the time shift outputting method according to the fifth aspect, preferably the initial random number value is a value obtained by calculating the random number value retained at random number retaining step with the one-way function at intervals of passage of predetermined time after starting of the storage of the encrypted data of the contents into the storage means. Further, preferably the number of times of the calculation of the initial random number value with the one-way function for producing a decrypting random number value is set in response to an interval of time after the encrypted data of the contents is stored into the storage means until the encrypted data of the contents is read out at the readout step.

According to a sixth aspect of the present invention, there is provided a time shift outputting method comprising a random number retaining step of retaining a random number value, which varies as time passes, at an arbitrary timing, a master encryption key retaining step of retaining a master encryption key, which varies as time passes, at an arbitrary timing, a step of changing the master encryption key retained at the master encryption key retaining step using the random number value retained at the random number retaining step to produce a work encryption key, a step of encrypting data of contents using the work encryption key to produce encrypted data, a step of storing the encrypted data into storage means, a readout step of reading out the encrypted data stored in the storage means when predetermined time passes after the encrypted data is stored, a step of decrypting the encrypted data read out at the readout step using the work encryption key, and a step of canceling at least any one of the retentions of the random number value retained at the random number retaining step and the master encryption key retained at the master encryption key retaining step after the decryption of the encrypted data of the contents ends.

According to a seventh aspect of the present invention, there is provided a time shift outputting method comprising a random number retaining step of retaining a random number value, which varies as time passes, at an arbitrary timing, a master encryption key retaining step of retaining a master encryption key, which varies as time passes, at an arbitrary timing, a step of changing the master encryption key retained at the master encryption key retaining step using the random number value retained at the random number retaining step to produce an encryption key, a step of encrypting data of contents using the encryption key to produce encrypted data, a step of storing the encrypted data into storage means, a readout step of reading out the encrypted data stored in the storage means when predetermined time passes after the encrypted data is stored, a step of changing the master encryption key retained at the master encryption key retaining step using the random number value retained at the random number retaining step to produce a decryption key, a step of decrypting the encrypted data read out at the readout step using the decryption key, and a step of canceling at least any one of the retentions of the random number value retained at the random number retaining step and the master encryption key retained at the master encryption key retaining step after the decryption of the encrypted data of the contents ends.

In the time shift outputting method according to the sixth or seventh aspect, preferably the retention of the master encryption key is cancelled when predetermined time passes after the storage of the encrypted data of the contents into the storage means is started. Alternatively, the retention of the master encryption key may be cancelled when predetermined time passes after the storage of the encrypted data of the contents into the storage means ends. Preferably, at least part of the master encryption key varies as time passes.

In the time shift outputting methods according to the second to seventh aspects, preferably the retention of the random number value retained at the random number retaining step is cancelled when predetermined time passes after the storage of the encrypted data of the contents into the storage means is started. Alternatively, the retention of the random number value retained at the random number retaining step may be cancelled when predetermined time passes after the storage of the encrypted data of the contents into the storage means ends.

According to an eighth aspect of the present invention, there is provided a time shift outputting method comprising a step of changing a master encryption key using a random number value, which varies as time passes, to produce a work encryption key, a work encryption key retaining step of retaining the work encryption key at an arbitrary timing, a step of encrypting data of contents using the work encryption key retained at the work encryption key retaining step to produce encrypted data, a step of storing the encrypted data into storage means, a readout step of reading out the encrypted data stored in the storage means when predetermined time passes after the encrypted data is stored, a step of decrypting the encrypted data read out at the readout step using the work encryption key retained at the work encryption key retaining step, and a step of canceling the retention of the work encryption key after the decryption of the encrypted data of the contents ends.

According to a ninth aspect of the present invention, there is provided a time shift outputting method comprising a step of changing a master encryption key, which varies as time passes, using a random number value, which varies as time passes, to produce a work encryption key, a work encryption key retaining step of retaining the work encryption key at an arbitrary timing, a step of encrypting data of contents using the work encryption key retained at the work encryption key retaining step to produce encrypted data, a step of storing the encrypted data into storage means, a readout step of reading out the encrypted data stored in the storage means when predetermined time passes after the encrypted data is stored, a step of decrypting the encrypted data read out at the readout step using the work encryption key retained at the work encryption key retaining step, and a step of canceling the retention of the work encryption key after the decryption of the encrypted data of the contents ends.

In the time shift outputting method according to the ninth aspect, preferably at least part of the master encryption key varies as time passes.

In the time shift outputting method according to the eighth or ninth aspect, preferably the retention of the work encryption key is cancelled when predetermined time passes after the storage of the encrypted data of the contents into the storage means is started. Alternatively, the retention of the work encryption key may be cancelled when predetermined time passes after the storage of the encrypted data of the contents into the storage means ends.

According to a tenth aspect of the present invention, there is provided a time shift outputting apparatus comprising key changing means for changing an encryption key as time passes, key retaining means for retaining the encryption key at an arbitrary timing, means for encrypting data of contents using the encryption key retained by the key retaining means to produce encrypted data, storage means for storing the encrypted data, readout means for reading out the encrypted data stored in the storage means when predetermined time passes after the encrypted data is stored, means for decrypting the encrypted data read out by the readout means using the encryption key retained by the key retaining means, and means for canceling the retention of the encryption key after the decryption of the encrypted data of the contents ends.

In the time shift outputting apparatus according to the tenth aspect, preferably it further comprises means for canceling the retention of the encryption key when predetermined time passes after the storage of the encrypted data of the contents into the storage means is started. Alternatively, it may further comprise means for canceling the retention of the encryption key when predetermined time passes after the storage of the encrypted data of the contents into the storage means ends. Preferably, the key changing means changes at least part of the encryption key as time passes.

According to an eleventh aspect of the present invention, there is provided a time shift outputting apparatus comprising random number generating means for generating a random number value which varies as time passes, random number value retaining means for retaining the random number value generated by the random number generating means at an arbitrary timing, means for changing a master encryption key using the random number value retained by the random number value retaining means to produce a work encryption key, means for encrypting data of contents using the work encryption key to produce encrypted data, means for storing the encrypted data, readout means for reading out the encrypted data stored in the storage means when predetermined time passes after the encrypted data is stored, means for decrypting the encrypted data read out by the readout means using the work encryption key, and means for canceling the retention of the random number value after the decryption of the encrypted data of the contents ends.

According to a twelfth aspect of the present invention, there is provided a time shift outputting apparatus comprising random number generating means for generating a random number value which varies as time passes, random number value retaining means for retaining the random number value generated by the random number generating means at an arbitrary timing, means for changing a master encryption key using the random number value retained by the random number value retaining means to produce an encryption key, means for encrypting data of contents using the encryption key to produce encrypted data, means for storing the encrypted data, readout means for reading out the encrypted data stored in the storage means when predetermined time passes after the encrypted data is stored, means for changing the master encryption key using the random number value retained by the random number value retaining means to produce a decryption key, means for decrypting the encrypted data read out by the readout means using the decryption key, and means for canceling the retention of the random number value retained by the random number value retaining means after the decryption of the encrypted data of the contents ends.

According to a thirteenth aspect of the present invention, there is provided a time shift outputting apparatus comprising random number generating means for generating a random number value which varies as time passes, random number value retaining means for retaining the random number value generated by the random number generating means at an arbitrary timing, means for encrypting data of contents using the random number value retained by the random number value retaining means to produce encrypted data, means for storing the encrypted data, readout means for reading out the encrypted data stored in the storage means when predetermined time passes after the encrypted data is stored, means for decrypting the encrypted data read out by the readout means using the random number value retained by the random number value retaining means, and means for canceling the retention of the random number value retained by the random number value retaining means after the decryption of the encrypted data of the contents ends.

According to a fourteenth aspect of the present invention, there is provided a time shift outputting apparatus comprising random number generating means for generating a random number value which varies as time passes, random number value retaining means for retaining the random number value generated by the random number generating means at an arbitrary timing, means for calculating the random number value retained by the random number value retaining means with a one-way function by a predetermined number of times to produce an encrypting random number value, means for changing the master encryption key using the encrypting random number value to produce an encryption key, means for encrypting data of contents using the encryption key to produce encrypted data, means for storing the encrypted data, readout means for reading out the encrypted data stored in the storage means when predetermined time passes after the encrypted data is stored, means for calculating the random number value retained by the random number value retaining means with the one-way function by the predetermined number of times to produce a decrypting random number value, means for changing the master encryption key using the decrypting random number value to produce a decryption key, means for decrypting the encrypted data read out by the readout means using the decryption key, and means for canceling the retention of the random number value retained by the random number value retaining means after the decryption of the encrypted data of the contents ends.

In the time shift outputting apparatus according to the fourteenth aspect, preferably the random number value is a value obtained by calculating the random number value retained by the random number value retaining means with the one-way function every time predetermined time passes after starting of the storage of the encrypted data of the contents into the storage means. Further, preferably the number of times of the calculation of the random number value retained by the random number value retaining means with the one-way function for producing the encrypting random number value may be set in response to an interval of time after the encrypted data of the contents is stored into the storage means until the encrypted data of the contents is read out by the readout means.

According to a fifteenth aspect of the present invention, there is provided a time shift outputting apparatus comprising random number generating means for generating a random number value which varies as time passes, random number value retaining means for retaining the random number value generated by the random number generating means at an arbitrary timing, master encryption key producing means for producing a master encryption key which varies as time passes, master encryption key retaining means for retaining the master encryption key produced by the master encryption key producing means at an arbitrary timing, means for changing the master encryption key retained by the master encryption key retaining means using the random number value retained by the random number value retaining means to produce a work encryption key, means for encrypting data of contents using the work encryption key to produce encrypted data, means for storing the encrypted data, readout means for reading out the encrypted data stored in the storage means when predetermined time passes after the encrypted data is stored, means for decrypting the encrypted data read out by the readout means using the work encryption key, and means for canceling at least any one of the retentions of the random number value retained by the random number value retaining means and the master encryption key retained by the master encryption key retaining means after the decryption of the encrypted data of the contents ends.

According to a sixteenth aspect of the present invention, there is provided a time shift outputting apparatus comprising random number generating means for generating a random number value which varies as time passes, random number value retaining means for retaining the random number value generated by the random number generating means at an arbitrary timing, master encryption key producing means for producing a master encryption key which varies as time passes, master encryption key retaining means for retaining the master encryption key produced by the master encryption key producing means at an arbitrary timing, means for changing the master encryption key retained by the master encryption key retaining means using the random number value retained by the random number value retaining means to produce an encryption key, means for encrypting data of contents using the encryption key to produce encrypted data, means for storing the encrypted data, readout means for reading out the encrypted data stored in the storage means when predetermined time passes after the encrypted data is stored, means for changing the master encryption key retained by the master encryption key retaining means using the random number value retained by the random number value retaining means to produce a decryption key, means for decrypting the encrypted data read out by the readout means using the decryption key, and means for canceling at least any one of the retentions of the random number value retained by the random number value retaining means and the master encryption key retained by the master encryption key retaining means after the decryption of the encrypted data of the contents ends.

In the time shift outputting apparatus according to the fifteenth or sixteenth aspect, preferably it further comprises means for canceling the retention of the master encryption key when predetermined time passes after the storage of the encrypted data of the contents into the storage means is started. Alternatively, it may further comprise means for canceling the retention of the master encryption key when predetermined time passes after the storage of the encrypted data of the contents into the storage means ends. Preferably, the master encryption key producing means produces the master encryption key at least part which varies as time passes.

In the time shift outputting apparatus according to the eleventh to sixteenth aspects, preferably it further comprises means for canceling the retention of the random number value retained by the random number retaining means when predetermined time passes after the storage of the encrypted data of the contents into the storage means is started. Alternatively, it may further comprise means for canceling the retention of the random number value retained by the random number retaining means when predetermined time passes after the storage of the encrypted data of the contents into the storage means ends.

According to a seventeenth aspect of the present invention, there is provided a time shift outputting apparatus comprising random number generating means for generating a random number value which varies as time passes, means for changing a master encryption key using the random number value generated by the random number value generating means to produce a work encryption key, work encryption key retaining means for retaining the work encryption key at an arbitrary timing, means for encrypting data of contents using the work encryption key retained by the work encryption key retaining means to produce encrypted data, means for storing the encrypted data, readout means for reading out the encrypted data stored in the storage means when predetermined time passes after the encrypted data is stored, means for decrypting the encrypted data read out by the readout means using the work encryption key retained by the work encryption key retaining means, and means for canceling the retention of the work encryption key after the decryption of the encrypted data of the contents ends.

According to an eighteenth aspect of the present invention, there is provided a time shift outputting apparatus comprising random number generating means for generating a random number value which varies as time passes, master encryption key producing means for producing a master encryption key which varies as time passes, means for changing the master encryption key using the random number value generated by the random number value generating means to produce a work encryption key, work encryption key retaining means for retaining the work encryption key at an arbitrary timing, means for encrypting data of contents using the work encryption key retained by the work encryption key retaining means to produce encrypted data, means for storing the encrypted data, readout means for reading out the encrypted data stored in the storage means when predetermined time passes after the encrypted data is stored, means for decrypting the encrypted data read out by the readout means using the work encryption key retained by the work encryption key retaining means, and means for canceling the retention of the work encryption key after the decryption of the encrypted data of the contents ends.

In the time shift outputting apparatus according to the eighteenth aspect, preferably the master encryption key producing means produces the master encryption key at least part of which varies as time passes.

In the time shift outputting apparatus according to the seventeenth or eighteenth aspect, preferably it further comprises means for canceling the retention of the work encryption key when predetermined time passes after the storage of the encrypted data of the contents into the storage means is started. Alternatively, it may further comprise means for canceling the retention of the work encryption key when predetermined time passes after the storage of the encrypted data of the contents into the storage means ends.

With the time shift outputting methods and the time shift outputting apparatus according to the present invention, an encryption key for decoding encrypted data of contents cannot be disabled from use after time shift reproduction ends or predetermined time passes after the encryption key is stored into the storing means. Consequently, the data of the contents can be temporarily stored, but cannot be duplicated. In other words, the temporarily stored contents can be invalidated and disabled from further utilization after the temporary storage. Therefore, the copyright of digital contents can be protected.

Further, by making it impossible to use the encryption key for decoding, the temporary stored encrypted data of the contents can be invalidated. Therefore, it is not necessary to perform an extra process for the data of the contents, and simplification of the apparatus configuration and miniaturization of the apparatus can be easily achieved.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1 is a block diagram showing a configuration of a time shift outputting apparatus to which the present invention is applied;

FIG. 2 is a waveform diagram illustrating an example of action of the time shift outputting apparatus of FIG. 1 upon time shift reproduction;

FIG. 3 is a waveform diagram similar to FIG. 2 but illustrating different action of the time shift outputting apparatus of FIG. 1 upon time shift reproduction;

FIG. 4 is a block diagram showing a modification to the time shift outputting apparatus of FIG. 1;

FIG. 5 is a waveform diagram illustrating an example of action of the time shift outputting apparatus of FIG. 4 upon time shift reproduction;

FIG. 6 is a block diagram showing another modification to the time shift outputting apparatus of FIG. 1;

FIG. 7 is a block diagram showing a configuration of a one-way function control circuit of the time shift outputting apparatus of FIG. 6;

FIG. 8 is a waveform diagram illustrating an example of action of the time shift outputting apparatus of FIG. 6 upon time shift reproduction;

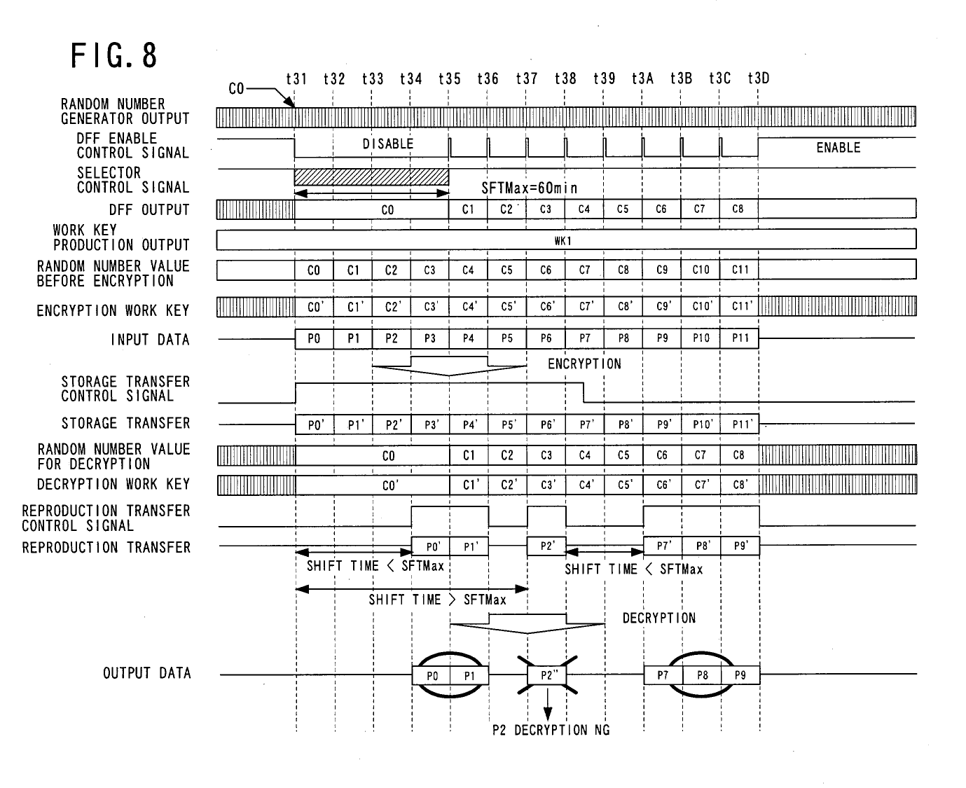

FIG. 9 is a block diagram showing a modification to the modified time shift outputting apparatus of FIG. 6;

FIG. 10 is a waveform diagram illustrating an example of action of the time shift outputting apparatus of FIG. 9 upon time shift reproduction;

FIG. 11 is a block diagram showing a configuration of a modification to the modified time shift outputting apparatus of FIG. 10;

FIG. 12 is a waveform diagram illustrating an example of action of the time shift outputting apparatus of FIG. 11 upon time shift reproduction;

FIG. 13 is a block diagram showing a configuration of another time shift outputting apparatus to which the present invention is applied;

FIG. 14 is a block diagram showing a configuration of a further time shift outputting apparatus to which the present invention is applied; and

FIG. 15 is a waveform diagram illustrating an example of action of the time shift outputting apparatus of FIG. 14 upon time shift reproduction.

### DESCRIPTION OF THE PREFERRED EMBODIMENTS

First Embodiment

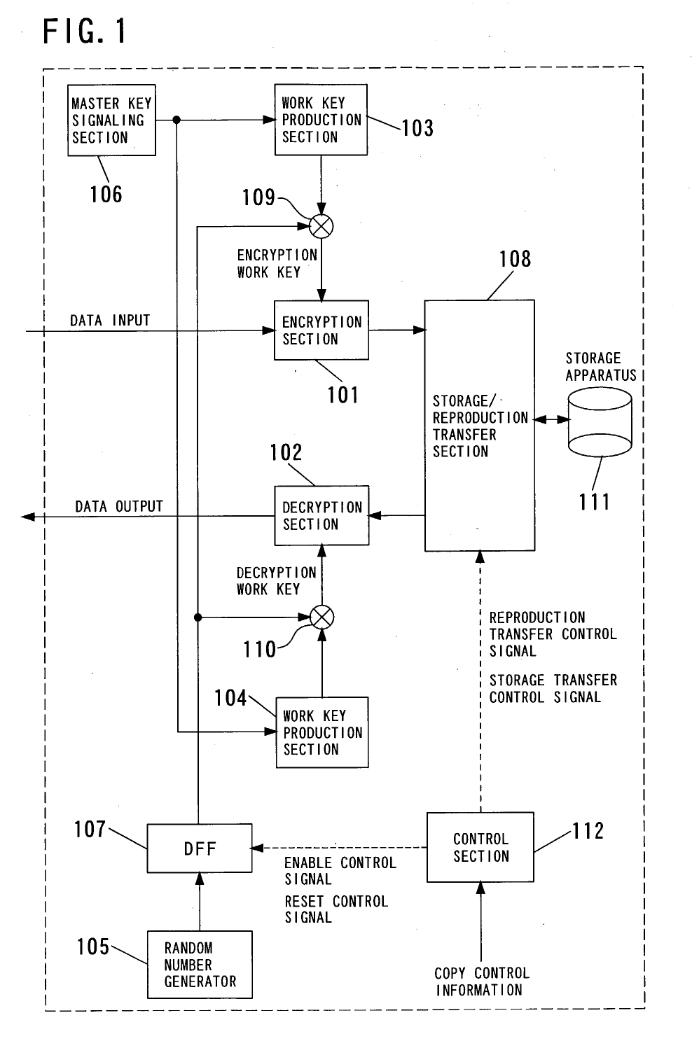

Referring first to FIG. 1, there is shown a time shift outputting apparatus to which the present invention is applied. The time shift outputting apparatus shown includes an encryption section 101, a decryption section 102, a pair of work key production sections 103 and 104, a random number generator 105, a master key signaling section 106, a delay flip-flop (DFF) 107, a storage/reproduction transfer section 108, a pair of exclusive OR gates (EXOR) 109 and 110, a storage apparatus 111 and a control section 112.

The encryption section 101 encrypts input data using an encryption work key. The decryption section 102 decrypts the encrypted data read out from the storage apparatus 111 using a decryption work key. It is to be noted that the work keys (encryption work key and decryption work key) are cryptographic keys used for actually encrypting and decrypting data and it is assumed here that the work keys are each represented by a binary number of a predetermined bit length. The work key production section 103 performs a predetermined conversion process for a master key signaled from the master key signaling section 106 to produce a work key from which a decryption work key is to be produced. The random number generator 105 generates a random number value of a predetermined bit length. The master key signaling section 106 outputs a master key on which the work keys are to be based to the work key production sections 103 and 104. It is to be noted that the master encryption key is represented by a binary number of a predetermined bit number similarly to the work encryption key. The delay flip-flop 107 latches and retains the random number value generated by the random number generator 105 in accordance with a control signal from the control section 112. The storage/reproduction transfer section 108 transfers data (encrypted data) encrypted by the encryption section 101 to the storage apparatus 111 in response to a storage transfer control signal from the control section 112 so that the storage apparatus 111 may store the encrypted data onto a storage medium. On the other hand, upon time shift reproduction, the storage/reproduction transfer section 108 successively reads out the encrypted data stored in the storage apparatus 111 in response to a reproduction transfer control signal from the control section 112 and transfers the encrypted data to the decryption section 102. The exclusive OR gate 109 exclusively ORs the work key produced by the work key production section 103 and the random number value outputted from the delay flip-flop 107 for individual bits and outputs a result of the exclusive ORing as an encryption work key. The exclusive OR gate 110 exclusively ORs the work key produced by the work key production section 104 and the random number value outputted from the delay flip-flop 107 for individual bits and outputs a result of the exclusive ORing as a decryption work key. The storage apparatus 111 is an apparatus for digitally storing information and includes a medium onto which information is to be stored. The medium may be a magnetic recording medium, an optical recording medium, a magneto-optical recording medium or the like. The storage apparatus 111 preferably is a randomly accessible storage medium. The control section 112 controls the delay flip-flop 107 and the storage/reproduction transfer section 108. In particular, the control section 112 controls the delay flip-flop 107 and the storage/reproduction transfer section 108 to encrypt and store input data into the storage apparatus 111 and then read out, after a shift (delay) for a predetermined period of time, and decode the stored data to realize “time shift outputting”.

Example 1 of Action

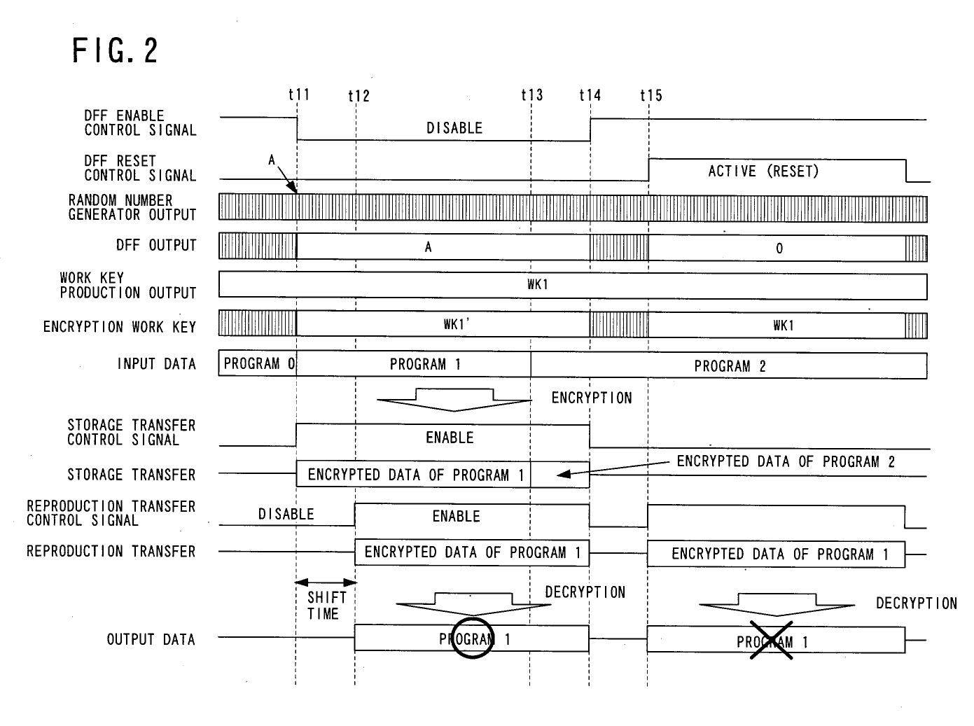

An example of action of the time shift outputting apparatus where the data input thereto is stream data of a digital broadcast or the like and time shift reproduction is performed for a particular program of the digital broadcast is described with reference to FIG. 2.

In this action, temporary storage for time shift reproduction is started at the top of a program 1 and reproduction is started after a time shift by arbitrary time, and the temporary storage and the time shift reproduction are ended at a point of time when the time shift reproduction is performed up to the last end of the program 1.

It is assumed that the input data is formed from a time series of a program 0, the program 1 and a program 2 as seen in FIG. 2. It is also assumed that copy of data of the programs is inhibited for the protection of the copyright, but only temporary storage of the data is permitted.

It is to be noted that, for simplified description, it is assumed that the work key production sections 103 and 104 normally output a value WK1 as the work keys. In other words, the work key production sections 103 and 104 output the same work key WK1 fixedly.

The control section 112 sets an enable control signal for the delay flip-flop 107 as a disable signal so that the delay flip-flop 107 may latch and retain an output of the random number generator 105. It is assumed here that a random number value A (≠0) is latched and retained by the delay flip-flop 107.

Meanwhile, the exclusive OR gate 109 exclusively ORs the work key WK1 and the random number value A and outputs a result of the exclusive ORing, that is, an exclusive OR value WK1′, as an encryption work key.

The encryption section 101 encrypts the data of the program 1 using the encryption work key WK1′. The encrypted data is stored into the storage apparatus 111 through the storage/reproduction transfer section 108. The storage of the data into the storage apparatus 111 is executed by the control section 112 transmitting a storage transfer control signal set as an enable (transfer valid) signal to the storage/reproduction transfer section 108. As a result, temporary storage is started at a starting point (t11) of time of the program 1.

Where time shift outputting is started at time t12 after passage of arbitrary shift time after the storage is started, the control section 112 controls the storage apparatus 111 to store the encrypted data of the program 1 into the storage apparatus 111 on one hand and to successively read out the encrypted data of the program 1 stored in the storage apparatus 111 beginning with the top of the program 1. The readout of the encoded data from the storage apparatus 111 is controlled by the control section 112 transmitting a reproduction transfer control signal set as an enable signal to the storage/reproduction transfer section 108. In other words, in this state, the control section 112 transmits the storage transfer control signal and the reproduction transfer control signal both as enable signals to the storage/reproduction transfer section 108.

At time t12, the exclusive OR value WK1′ of the work key WK1 and the random number A is outputted as a decryption work key from the exclusive OR gate 110. Consequently, the decryption section 102 decrypts the encrypted data of the program 1 acquired from the storage/reproduction transfer section 108 using the decryption work key WK1′. Since the work key used for the decryption is the work key WK1′ and same as the work key used for the encryption, the encrypted data of the program 1 is restored normally.

Also after the program 1 comes to an end (at time t13), the control section 112 controls the storage/reproduction transfer section 108 to store the encrypted input data into the storage apparatus 111. In other words, also after the program 1 comes to an end, the control section 112 transmits the storage transfer control signal as an enable signal to the storage/reproduction transfer section 108. Consequently, the encrypted data of the program 2 is stored into the storage apparatus 111.

At a point of time when the time shift reproduction is performed up to the end of the program 1 (at time t14), the control section 112 transmits the storage transfer control signal and the reproduction transfer control signal both as disable signals to the storage/reproduction transfer section 108. Consequently, the time shift outputting apparatus ends the temporary storage and the time shift reproduction.

Further, the control section 112 changes over the enable control signal for the delay flip-flop 107 to an enable signal to cancel the latched random number value A in the delay flip-flop 107. Consequently, after the time shift reproduction comes to an end, the work key WK1′ used then is disabled from further use. In other words, the random number value used as a factor in production of a work key is rendered non-restorable thereby to render the work key itself non-restorable.

Since the work key has been rendered non-restorable, the encrypted data of the program 1 stored in the 111 cannot be encrypted any more using a work key coincident with the work key used for the encryption. Consequently, the encrypted data stored in the storage apparatus 111 is invalidated and disabled from further use.

Here, it is assumed to try to reproduce the data of the program 1 temporarily stored and remaining in the storage apparatus 111 again after the time shift reproduction comes to an end.

If it is tried to reproduce the data of the program 1 temporarily stored and remaining in the storage apparatus 111 again at time t15 after the time shift reproduction comes to an end, then the control section 112 transmits the reproduction transfer control signal as an enable signal to the storage/reproduction transfer section 108.

Further, the control section 112 sends the reset control signal as an active signal to the delay flip-flop 107 so that the delay flip-flop 107 outputs zero within a reproduction transfer period. Since the work key production section 104 normally outputs the work key WK1, the exclusive OR gate 110 outputs an exclusive OR value of the work key WK1 and 0, that is, the work key WK1, as a decryption work key. The decryption work key WK1 obtained here does not coincide with the encryption work key WK1′ which was used for the encryption of the data of the program 1. Consequently, even if the encrypted data of the program 1 is decrypted using the work key WK1 as a decryption work key, the data of the program 1 is not restored normally. Consequently, the encrypted data of the program 1 stored in the storage apparatus 111 is invalidated and non-restorable.

It is to be noted that, even if the storage apparatus 111 otherwise does not transmit a reset control signal to the delay flip-flop 107, since the random number value outputted from the delay flip-flop 107 does not coincide with the random number value A, it is apparent that the encryption work key WK1′ used for the encryption of the data of the program cannot be obtained.

Example 2 of Action

A second example of action where a data input is assumed as stream data of a digital broadcast and the time shift outputting apparatus performs time shift reproduction for a particular program of the digital broadcast is described.

In this action, temporary storage for time shift reproduction is started at the top of a program 1 and reproduction is started after a time shift by arbitrary time, and the temporary storage and the time shift reproduction are ended at a point of time when the time shift reproduction is performed up to the last end of the program 1, similarly as in the example 1 of action described above.

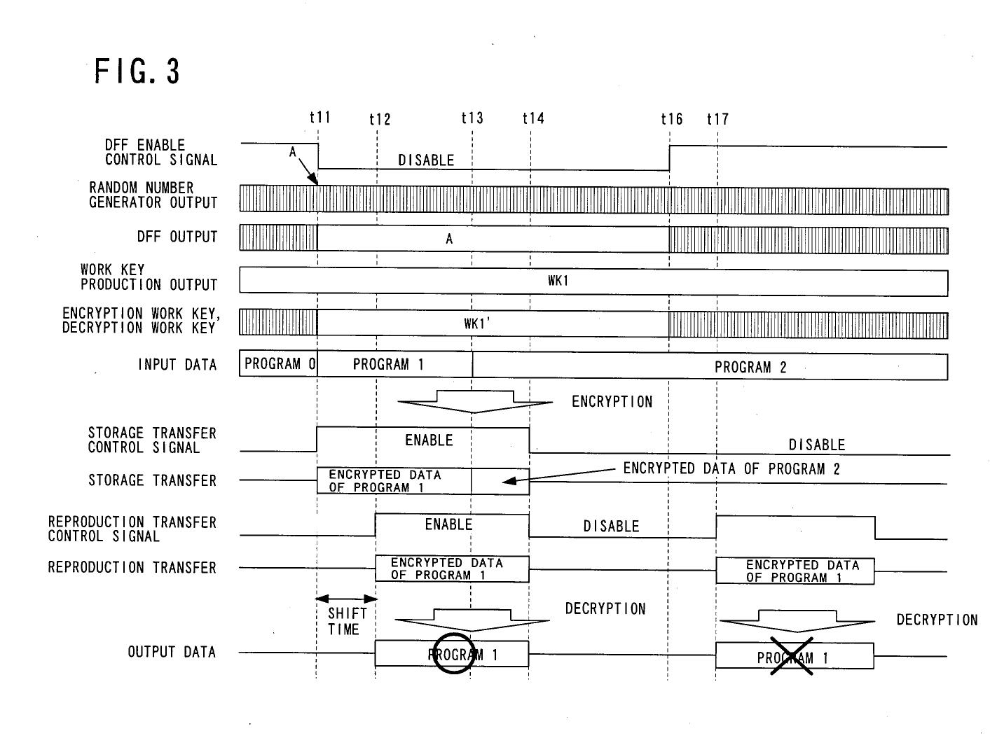

It is assumed that the input data is formed from a time series of a program 0, the program 1 and a program 2 as seen in FIG. 3. It is also assumed that copy of data of the programs is inhibited for the protection of the copyright, but only temporary storage of the data is permitted.

It is to be noted that, for simplified description, it is assumed that the work key production sections 103 and 104 normally output WK1 as the work keys. In other words, the work key production sections 103 and 104 output the same work key WK1 fixedly.

Action of the time shift outputting apparatus at times t11 to t13 is similar to that in the example 1 of action described above.

At a point of time when the time shift reproduction is performed up to the end of the program 1 (at time t14), the control section 112 transmits the storage transfer control signal and the reproduction transfer control signal both as disable signals to the storage/reproduction transfer section 108. Consequently, the time shift outputting apparatus ends the temporary storage and the time shift reproduction. The control section 112 supervises the passed time after the end of the time shift reproduction.

When a predetermined period of time passes (t16) after the end (t14) of the temporary storage, the control section 112 changes over the enable control signal for the delay flip-flop 107 to an enable signal to cancel the latched random number value A in the delay flip-flop 107. Consequently, after the predetermined period of time passes after the end of the time shift reproduction, the work key WK1 used for the encryption cannot be used any more. In other words, the random number value used as a factor in production of the work keys is rendered non-restorable thereby to render the work key itself non-restorable.

Consequently, similarly as in the example 1 of action, the encrypted data stored in the storage apparatus 111 is invalidated and disabled from further use. If it is tried to perform time shift reproduction, for example, at the point of time t17, then since the random number value A is not outputted from the delay flip-flop 107, the encrypted data of the program 1 cannot be decrypted normally.

Although, in the present example of action, the control section 112 supervises the passed time after the end of the temporary storage and cancels the latched random number value in the delay flip-flop 107 when the predetermined time passes, when predetermined time passes after starting of temporary storage, otherwise the control section 112 may transmit an enable control signal to the delay flip-flop 107 to cancel a latched random number value in the delay flip-flop 107.

In this manner, in the time shift outputting apparatus of the present embodiment, since an encryption key used for temporary storage is disabled from further use at a point of time when the time shift reproduction comes to an end or at a point of time at which predetermined time passes after the encrypted data is stored, there is no necessity to perform special file management for invalidating encoded data stored in the storage apparatus 111.

Further, since the countermeasure for invalidating the encrypted data stored in the storage apparatus 111 is implemented by a random number generator, a delay flip-flop and an exclusive OR circuit, an increase of the gate scale where the time shift outputting apparatus is constructed using an LSI or the like can be suppressed.

Furthermore, since a work key produced for temporary storage is closed within the hardware and cannot be peeked in systematically, that is, a random number value on which a work key is based, is latched and retained in the delay flip-flop 107, it is impossible to illegally refer to the random number value to suppose an algorithm of the cryptography. Consequently, the effect in prevention of alteration to or illegal copying of a stream is high and the security for the protection of the copyright can be raised.

First Modification to the First Embodiment

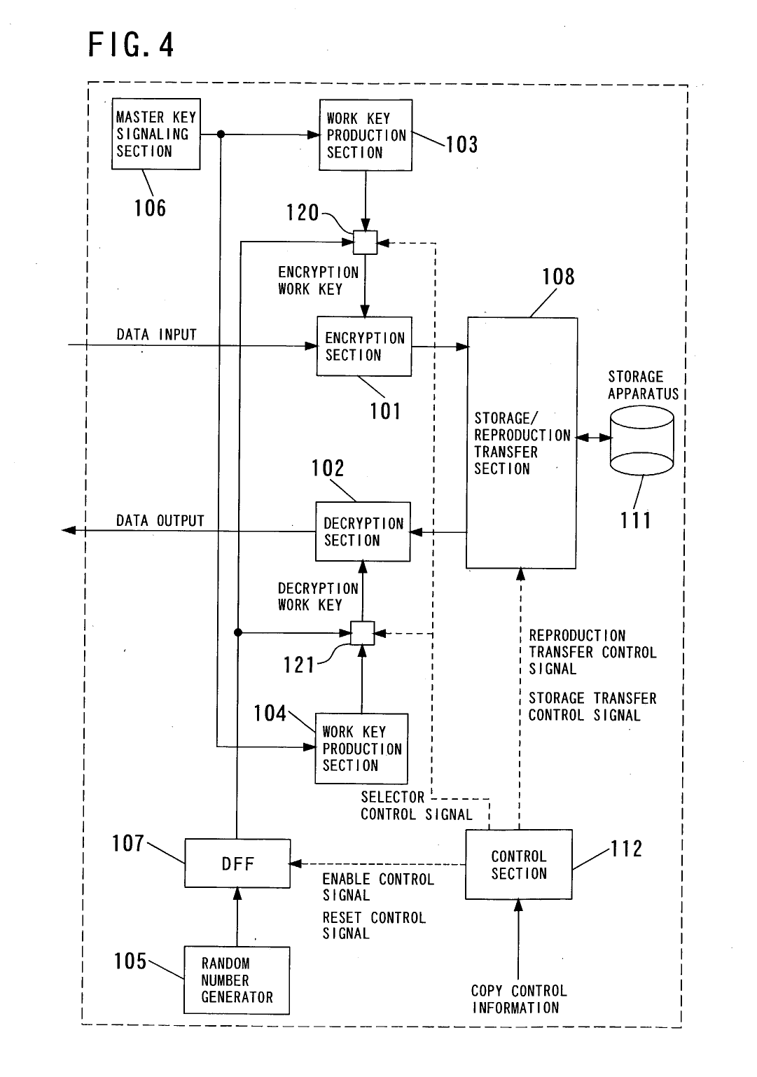

Referring now to FIG. 4, there is shown another time shift outputting apparatus to which the present invention is applied. The time shift outputting apparatus is a modification to and is different from the time shift outputting apparatus of the first embodiment shown in FIG. 1 in that it includes selectors 120 and 121 in place of the exclusive OR gates 109 and 110, respectively. In the following, description is given of the different features.

The control section 112 controls the delay flip-flop 107, storage/reproduction transfer section 108 and selectors 120 and 121. In particular, the control section 112 controls them to encrypt and store input data into the storage apparatus 111 and then read out and decrypt the data after a shift or delay of a predetermined interval of time to realize “time shift outputting”.

The selector 120 selectively outputs one of a work key WK1 outputted from the work key production section 104 and a random number value latched in the delay flip-flop 107 as a decryption work key in accordance with a selector control signal outputted from the control section 112. Meanwhile, the selector 121 selectively outputs one of the work key WK1 outputted from the work key production section 103 and the random value latched in the delay flip-flop 107 as an encryption work key in accordance with the selector control signal outputted from the control section 112.

In other words, when the time shift outputting apparatus of the present modification performs temporary storage, data of the random number value is selectively used as it is as an encryption work key to be used for encryption and a decryption work key to be used for decryption.

Subsequently, description is given of action of the time shift outputting apparatus of the present modification when it performs, under the assumption that a data input thereto is stream data of a digital broadcast or the like, time shift reproduction for a particular program of the digital broadcast. In this action, temporary storage for time shift reproduction is started at the top of a program 1 and reproduction is started after a time shift by arbitrary time, and the temporary storage and the time shift reproduction are ended at a point of time when the time shift reproduction is performed up to the last end of the program 1.

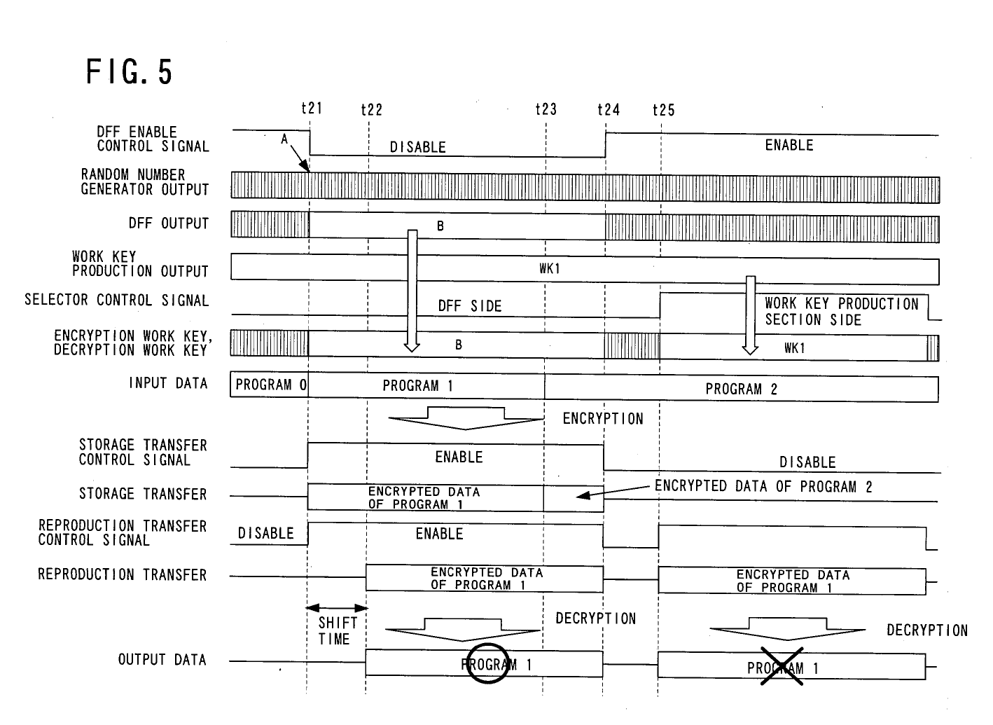

It is assumed that the input data is formed from a time series of a program 0, the program 1 and a program 2 as seen in FIG. 5. It is also assumed that copy of data of the programs is inhibited for the protection of the copyright, but only temporary storage of the data is permitted.

It is to be noted that, for simplified description, it is assumed that the work key production sections 103 and 104 normally output WK1 as the work keys. In other words, the work key production sections 103 and 104 output the same work key WK1 fixedly.

The control section 112 sets an enable control signal for the delay flip-flop 107 as a disable signal at time 21 so that an output of the random number generator 105 is latched and retained by the delay flip-flop 107. Here, it is assumed that a random number value B (≠0) is latched in the delay flip-flop 107.

Further, the control section 112 transmits a selector control signal for selecting an input of the delay flip-flop 107 side to the selectors 120 and 121. Consequently, the selector 120 outputs the random number value B inputted thereto from the delay flip-flop 107 as an encryption work key. Meanwhile, the selector 121 outputs the random number value B inputted thereto from the delay flip-flop 107 as a decryption work key.

The encryption section 101 encrypts the data of the program 1 using the encryption work key B. The encrypted data is stored into the storage apparatus 111 through the storage/reproduction transfer section 108. Such storage of the data into the storage apparatus 111 is executed by the control section 112 transmitting a storage transfer control signal as an enable signal to the storage/reproduction transfer section 108. Thus, temporary storage is started at the starting point of time (t21) of the program 1.

Where time shift outputting is started at time t22 after passage of arbitrary time after the storage is started, the control section 112 controls the storage/reproduction transfer section 108 to store the encrypted data of the program 1 into the storage apparatus 111 and successively read out the encrypted data of the program 1 stored in the storage apparatus 111 beginning with the top of the program 1. Such readout of the encrypted data from the storage apparatus 111 is controlled by the control section 112 transmitting a reproduction transfer control signal as an enable signal to the storage/reproduction transfer section 108. In other words, in this state, the control section 112 transmits a storage transfer control signal and a reproduction transfer control signal both as enable signals to the storage/reproduction transfer section 108.

At time t22, the random number value B is outputted as a decryption work key from the selector 121. Consequently, the decryption section 102 decrypts the encrypted data of the program 1 acquired from the storage/reproduction transfer section 108 using the decryption work key B. Since the work key used for decryption is the random number value B and same as the work key used for the encryption, the encoded data of the program 1 is regenerated normally.

Also after the program 1 comes to an end (t32), the control section 112 stores the encoded input data into the storage apparatus 111 through the storage/reproduction transfer section 108. In other words, the control section 112 transmits the storage transfer control signal as an enable signal to the storage/reproduction transfer section 108 also after the end of the program 1. Consequently, the encoded data of the program 2 is stored into the storage apparatus 111.

At a point of time when the time shift reproduction is performed up to the end of the program 1 (t24), the control section 112 transmits the storage transfer control signal and the reproduction transfer control signal both as disable signals to the storage/reproduction transfer section 108. Consequently, the time shift outputting apparatus ends the temporary storage and the time shift reproduction.

Further, the control section 112 changes over the enable control signal for the delay flip-flop 107 to an enable signal to cancel the latching of the random number value B in the delay flip-flop 107. Consequently, after the time shift reproduction comes to an end, the random number value B currently used as the encryption work key and the decryption work key is disabled from further use.

It is to be noted that the time shift reproduction apparatus of the present modification may be further modified such that, similarly as in the time shift reproduction apparatus of the first embodiment described above, the control section 112 transmits an enable control signal to the delay flip-flop 107 to cancel the latching of a random value in the delay flip-flop 107 when a predetermined interval of time passes after temporary storage is started or after temporary storage comes to an end.

Since the work keys cannot be restored any more, the encrypted data of the program 1 stored in the storage apparatus 111 cannot be decrypted using a work key which coincide with the work key used for the encryption. Consequently, the encrypted data stored in the storage apparatus 111 is invalidated and disabled from further use.

Here, it is assumed to try to reproduce the data of the program 1 temporarily stored and remaining in the storage apparatus 111 again after the time shift reproduction comes to an end.

If it is tried to reproduce the encrypted data of the program 1 temporarily stored in the storage apparatus 111 again at time t25 after the time shift reproduction comes to an end, then the control section 112 transmits the reproduction transfer control signal as an enable signal to the storage/reproduction transfer section 108. Further, the control section 112 sends a selector control signal for selecting an input of the work key production section 104 side to the selector 121 so that the work key WK1 is outputted as a decryption work key within the reproduction transfer period.

The decryption work key WK1 obtained here does not coincide with the encryption work key B which was used for the encryption of the data of the program 1. Consequently, even if the encrypted data of the program 1 is decrypted using the work key WK1 as a decryption work key, the data of the program 1 is not restored normally. In this manner, the encrypted data of the program 1 stored in the storage apparatus 111 is invalidated and non-restorable.

It is to be noted that, even if the control section 112 controls the selector 121 to select an input of the delay flip-flop 107 side, the random number value outputted from the delay flip-flop 107 apparently does not coincide with the encryption work key B which was used for the encryption of the data of the program 1.

In this manner, also with the time shift outputting apparatus of the present modification, similarly with that of the first embodiment, temporarily stored stream data can be invalidated and disabled from reproduction without the necessity for any special file management after time shift reproduction comes to an end. Consequently, the copyright of contents provided to a user of a digital broadcast can be protected.

Further, since the configuration for invalidating encrypted data stored in the storage apparatus 111 is implemented by the random number generator 105, delay flip-flop 107 and selectors 120 and 121, an increase of the gate scale where the time shift outputting apparatus is configured using an LSI or the like can be suppressed.

Furthermore, since a work key used for temporary storage is closed in hardware and cannot be peeked in systematically, or in other words, since a random number value from which a work key is to be produced is latched in the delay flip-flop 107, it is impossible to illegally refer to the random number to suppose an algorithm of the cryptography. Consequently, a high effect in prevention of alteration to or illegal copying of a stream can be achieved and the security for the protection of the copyright can be raised.

Second Modification to the First Embodiment

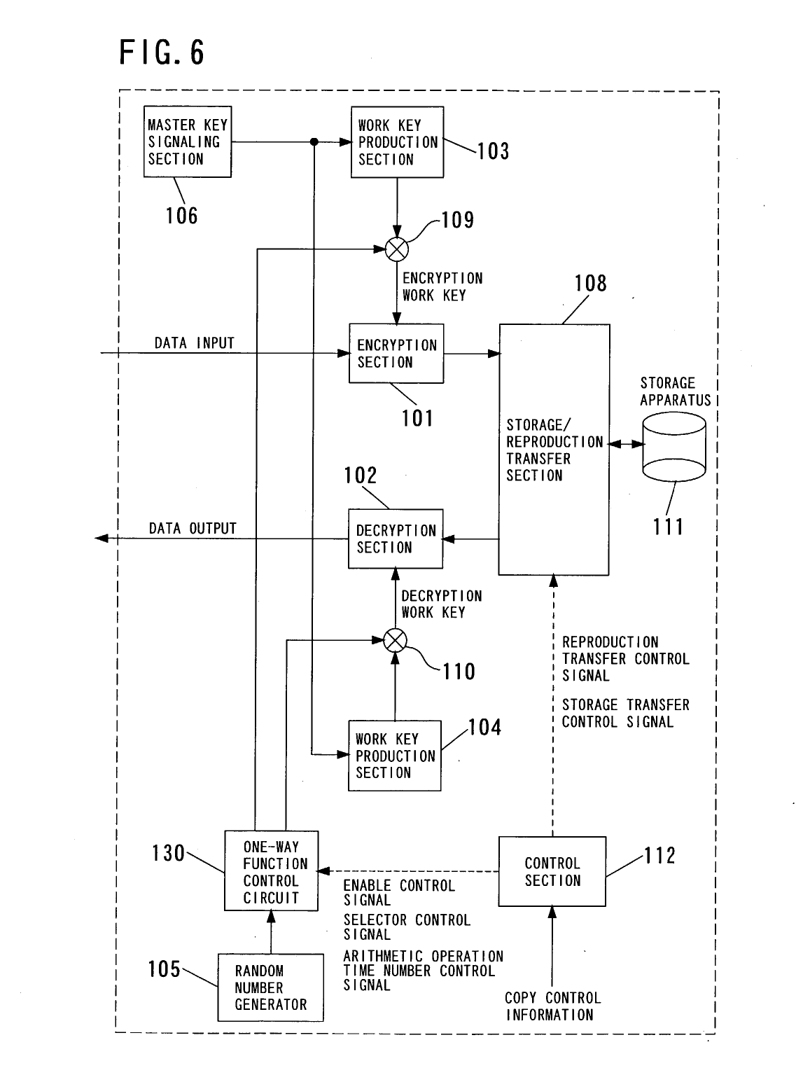

Referring now to FIG. 6, there is shown a further time shift outputting apparatus to which the present invention is applied. The present time shift outputting apparatus is a modification to but is different from the time shift outputting apparatus of the first embodiment shown in FIG. 1 in that it includes a one-way function control circuit 130 in place of the delay flip-flop 107. In the following, description is given of the different feature.

The exclusive OR gate 109 exclusively ORs a work key produced by the work key production section 103 and a random number value for decryption outputted from the one-way function control circuit 130 for individual bits and outputs a result of the exclusive ORing as an encryption work key. The exclusive OR gate 110 exclusively ORs a work key produced by the work key production section 104 and a random number value for decryption outputted from the one-way function control circuit 130 for individual bits and outputs a result of the exclusive ORing as a decryption work key. The control section 112 controls the storage/reproduction transfer section 108 and the exclusive OR gate 109. In particular, the control section 112 controls them to encrypt and store input data into the storage apparatus 111 and then read out, after a shift (delay) for a predetermined period of time, and decode the stored data from the storage apparatus 111 to realize “time shift outputting”.

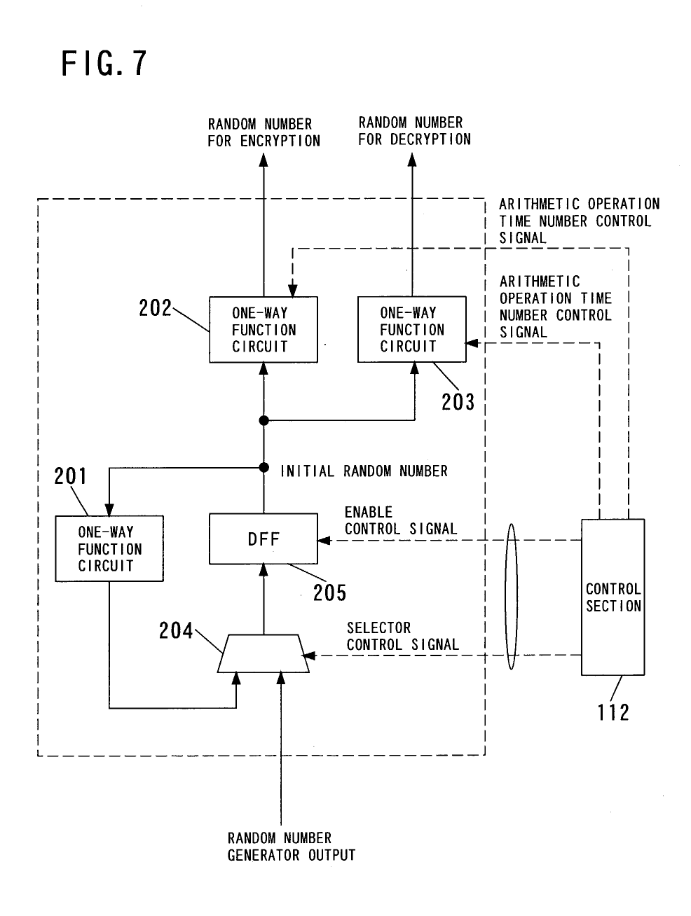

FIG. 7 shows the one-way function control circuit 130. Referring to FIG. 7, the one-way function control circuit 130 includes one-way function circuits 201, 202 and 203, a selector 204 and a delay flip-flop 205.

Each of the one-way function circuits 201, 202 and 203 arithmetically operates a value inputted thereto with a function whose calculation in the positive direction is easy whereas calculation thereof in the opposite direction is very difficult, that is, a one-way function, and outputs a value obtained by the calculation of the one-way function. In particular, each of the one-way function circuits 201, 202 and 203 varies a value inputted thereto in accordance with a one-way function. It is to be noted that each of the one-way function circuits 201, 202 and 203 may vary all bits of the value inputted thereto or may otherwise vary only some of the value inputted thereto such as, for example, a predetermined number of higher order bits or lower order bits. The selector 204 selectively inputs one of the random number value inputted from the random number generator 105 and the value outputted from the one-way function circuit 201 to the delay flip-flop 205 in accordance with a select control signal from the control section 112. The delay flip-flop 205 latches the value inputted thereto from the selector 204 in accordance with a control signal from the control section 112.

Subsequently, description is given of action of the time shift outputting apparatus of the present modification when it performs, under the assumption that a data input thereto is stream data of a digital broadcast or the like, time shift reproduction for a particular program of the digital broadcast. In this action, temporary storage for time shift reproduction is started at the top of a program P0 and reproduction is started after a time shift by arbitrary time, and the temporary storage and the time shift reproduction are ended at a point of time when the time shift reproduction is performed up to the last end of a different program P11.

It is assumed that input data is formed from a time series of programs P0, P1, P2, . . . , P11, and the time of each program is 15 minutes. Also it is assumed that maximum permission time SFTMax of time shift reproduction is 60 minutes and the time shift reproduction is limited such that, while normal reproduction can be performed where the shift time is shorter than 60 minutes, where the shift time is equal to or longer than 60 minutes, time shift reproduction cannot be performed.

Further, it is assumed that copy of data of the programs is inhibited in order to protect the copyright, but only temporary storage of the data is permitted.

Furthermore, for simplified description, it is assumed that the work key production sections 103 and 104 normally output a value WK1 as a work key. In other words, the work key production sections 103 and 104 output the work key WK1 fixedly.

In addition, it is assumed that the one-way function circuits 201, 202 and 203 use the same one-way function to perform arithmetic operation for an input value, and where the input value is represented by “X” while the output value is represented by “Y” and the number of times of arithmetic operation is “n” (n≧0), the function is represented as Y=F(x, n). More particularly, the function is such that, where X=Ca and n=b, Y=Cc is obtained, where c=a+b. Consequently, where (X, n)=(C0, 1), Y=C1 is obtained; where (X, n)=(C1, 1), Y=C2 is obtained; where (X, n)=(C0, 2), Y=C2 is obtained; and where (X, n)=(C0, 0), Y=C0 is obtained.

The control section 112 transmits a selector control signal to the selector 204 at time t31 so that the selector 204 selects the random number generator 105, and transmits an enable control signal for the delay flip-flop 205 as a disable signal to the delay flip-flop 205 so that the delay flip-flop 205 latches an output of the random number generator 105. Here, it is assumed that the random number C0 (≠0) is latched by the delay flip-flop 205.

Further, the control section 112 sets the number of times of arithmetic operation to 0 and transmits an arithmetic operation time number control signal representing this to the one-way function circuit 202. Consequently, the random number value C0 latched in the delay flip-flop 205 is outputted as it is as a random number value for encryption from the one-way function circuit 202.

The exclusive OR gate 109 exclusively ORs the work key WK1 outputted from the work key production section 103 and the value C0 outputted as a random number value for encryption from the one-way function control circuit 130 and outputs a result of the exclusive ORing, that is, a value C0′, as an encryption work key.

The encryption section 101 uses the encryption work key C0′ to encrypt the data of the program P0. The encoded data is stored into the storage apparatus 111 through the storage/reproduction transfer section 108. Such storage of the data into the storage apparatus 111 is executed by the control section 112 transmitting a storage transfer control signal as an enable signal to the storage/reproduction transfer section 108. Consequently, temporary storage is started at the starting point of time (t31) of the program 1.

At time t32, the control section 112 sets the arithmetic operation time number to 1 and transmits an arithmetic operation time number control signal representing this to the one-way function circuit 202. Consequently, Y=(C0, 1)=C1 is outputted as a random number value for encryption from the one-way function circuit 202.

The decryption section 102 exclusively ORs the work key WK1 outputted from the work key production section 103 and the value C1 outputted as a random number value for encryption from the one-way function control circuit 130 and outputs a result of the exclusive ORing, that is, a value C1′, as an encryption work key.

The encryption section 101 uses the encryption work key C1′ to encrypt the data of the program P1. The encrypted data is stored into the storage apparatus 111 through the storage/reproduction transfer section 108 in a similar manner as described above.

At time t33, the control section 112 sets the arithmetic operation time number to 2 and transmits an arithmetic operation time number control signal representing this to the one-way function circuit 202. Consequently, Y=(C0, 2)=C2 is outputted as a random number value for encryption from the one-way function circuit 202.

The exclusive OR gate 109 exclusively ORs the work key WK1 outputted from the work key production section 103 and the value C2 outputted as a random value for encryption from the one-way function control circuit 130 and outputs a result of the exclusive ORing, that is, a value C2′, as an encryption work key.

The encryption section 101 uses the encryption work key C2′ to encrypt the data of the program P2. The encrypted data is stored into the storage apparatus 111 through the storage/reproduction transfer section 108 in a similar manner as described above.

At step t34, the control section 112 sets the arithmetic operation time number to 3 and transmits an arithmetic operation time number control signal representing this to the one-way function circuit 202. Consequently, Y=(C0, 3)=C3 is outputted as a random number value for encryption from the one-way function circuit 202.

The exclusive OR gate 109 exclusively ORs the work key WK1 outputted from the work key production section 103 and the value C3 outputted as a random number value for encryption from the one-way function control circuit 130 and outputs a result C3′ of the exclusive ORing as an encryption work key.

The encryption section 101 uses the encryption work key C3′ to encrypt the data of the program P3. The encrypted data is stored into the storage apparatus 111 through the storage/reproduction transfer section 108 in a similar manner as described above.

At time t35 after the shift maximum permission time SFTMax passes after the temporary storage is started, that is, after passage of 60 minutes, the control section 112 transmits a selector control signal to the selector 204 so that the selector 204 selects an output of the one-way function circuit 201. Further, the control section 112 sets the enable control signal for the delay flip-flop 205 first as an enable signal once and then as a disable signal so that the delay flip-flop 205 latches the random number value C1.

Furthermore, the control section 112 sets the arithmetic operation time number to 3 and outputs an arithmetic operation time number control signals representing this to the one-way function circuit 202. Consequently, the one-way function circuit 202 outputs Y=(C1, 3)=C4 as a random number value for encryption.

The exclusive OR gate 109 exclusively ORs the work key WK1 outputted from the work key production section 103 and the value C4 outputted as a random number value for encryption from the one-way function control circuit 130 and outputs a result C4′ of the exclusive ORing as an encryption work key.

The encryption section 101 uses the encryption work key C4′ to encrypt the data of the program P4. The encrypted data is stored as encrypted data P4′ into the storage apparatus 111 through the storage/reproduction transfer section 108 in a similar manner as described above.

At time t36 after the shift maximum permission time SFTMax+15 minutes, that is, 75 minutes, pass after the temporary storage is started, the control section 112 sets the enable control signal for the delay flip-flop 205 first as an enable signal and then as a disable signal so that the delay flip-flop 205 latches the random number value C2.

Further, the control section 112 sets the arithmetic operation time number to 3 and outputs an arithmetic operation time number control signal representing this to the one-way function circuit 202. Consequently, the one-way function circuit 202 outputs Y=(C2, 3)=C5 as a random number value for encryption.

The exclusive OR gate 109 arithmetically operates the work key WK1 outputted from the work key production section 103 and the value C5 outputted as a random number value for encryption from the one-way function control circuit 130 and outputs a result C5′ of the exclusive ORing as an encryption work key.

The encryption section 101 uses the encryption work key C5′ to encrypt the data of the program P5. The encrypted data is stored as encoded data P5′ into the storage apparatus 111 through the storage/reproduction transfer section 108 in a similar manner as described above.

Thereafter, the control section 112 performs control of setting the enable control signal for the delay flip-flop 205 first as an enable signal and then as a disable signal after every 15 minutes. Through the control, the control section 112 changes the value to be latched into the delay flip-flop 205 based on the one-way function for every 15 minutes. Further, the control section 112 sends an arithmetic operation time number control signal representing that the arithmetic operation time number is 3 to the one-way function circuit 202 so that the one-way function circuit 202 outputs a random number value for encryption. Since an encryption work key outputted from the encryption section 101 is a result of exclusive ORing of the work key WK1 outputted from the work key production section 103 and a random number value for encryption, also the encryption work key changes every time the random number value for encryption changes after every 15 minutes.

The encryption section 101 encrypts later data of the program P5 and so forth using an encryption work key in a similar manner as described above. The encrypted data is stored into the storage apparatus 111.

The control section 112 performs time shift reproduction of the encrypted data stored in the storage apparatus 111 in this manner after an arbitrary interval of shift time passes after the temporary storage is performed.

Here, it is assumed that the encrypted data P0′ and P1′ are reproduced after a time shift (delay) of 45 minutes, the encrypted data P2′ is reproduced after a time shift (delay) of 60 minutes, and the encrypted data P7′, P8′ and P9′ are reproduced after a time shift (delay) of 30 minutes.

When time shift reproduction of the encrypted data of each program is to be performed, the control section 112 transmits an arithmetic operation time number control signal based on the shift time to the one-way function circuit 203 so that the one-way function circuit 203 outputs the same value as the random number value for encryption used for the encryption of the data.

More particularly, for 15 minutes (t34 to t35) for which time shift reproduction of the encrypted data P0′ is performed, the output of the delay flip-flop 205 is C0 and the random number value for encryption used for decryption of P0′ is C0, and therefore, the control section 112 controls so that the one-way function circuit 203 outputs a random number value for decryption as F(C0, 0)=C0. For 15 minutes (t35 to t36) for which time shift reproduction of the encrypted data P1′ is performed, the output of the delay flip-flop 205 is C1 and the random number value for encryption used for the encryption of P1′ is C1, and therefore, the control section 112 controls so that the random number value for encryption is obtained as F(C1, 0)=C1. Similarly, for 15 minutes (t37 to t38) for which time shift reproduction of the encrypted data P2′ is performed, the random number value for decryption is obtained as F(C3, 0)=C3; for 15 minutes (t3A to t3B) for which time shift reproduction of the encrypted data P7′ is performed, the random number value for decryption is obtained as F(C6, 1)=C7; for 15 minutes (t3B to t3C) for which time shift reproduction of the encrypted data P8′ is performed, the random number value for decryption is obtained as F(C7, 1)=C8; and for 15 minutes (t3C to t3D) for which time shift reproduction of the encrypted data P9′ is performed, the random number value for decryption is obtained as F(C8, 1)=C9.

The exclusive OR gate 110 exclusively ORs the work key WK1 normally outputted from the work key production section 104 and the random number values for decryption (C0, C1, C3, C7, C8 and C9) successively outputted from the one-way function control circuit 130 at timings for time shift reproduction of the individual encoded data and successively outputs results of the exclusive ORing (C0, C1′, C3′, C7′, C8′ and C9′) as decryption work keys.

The decryption section 102 decrypts the encoded data using the respective decryption work keys at the respective reproduction timings.

In the example described above, the encoded data P0′, P1′, P6′, P7′ and P8′ are decrypted normally because the reproduction shift time is shorter than the shift maximum permission time SFTMax, and output data P0, P1, P6, P7 and P8 are obtained, respectively. However, the encoded data P2′ is not decrypted normally because the reproduction shift time is 60 minutes and longer than the shift maximum permission time SFTMax, and output data P2″ different from the inputted data P2 is outputted.

In order to decrypt the encrypted data P2′ normally, it is necessary to use the decryption work key C2′ for decryption, and in order to obtain the decryption work key C2′, C0 or C1 must be latched in the delay flip-flop 205.

In the present modification, since shift time limitation control for less than 60 minutes is performed for the one-way function control circuit 130, a decryption work key different from that to be applied originally is allocated to encoded data whose time shift reproduction is attempted exceeding the limitation so that normal decryption of the encoded data cannot be performed. For example, in the example described above, to the encoded data P2, not the decryption work key C2′ to be applied originally but the different decryption work key C3′ is allocated. Since it is difficult from the characteristic of a one-way function to calculate the decryption work key C2′ based on the decryption work key C3′, a high degree of key security can be achieved.

With the time shift outputting apparatus of the present modification, since the applicable encryption work key is changed using a one-way function or the like every time a predetermined interval of time passes, there is an advantage that a limitation can be provided to time for which time shift reproduction of temporarily stored data can be performed in addition to advantages similar to those of the time shift outputting apparatus of the first embodiment.

It is to be noted that, while, in the time shift outputting apparatus of the present modification, the period for changing the encryption work key is set to 15 minutes, if the period is changed to a shorter one, then a more precise limitation can be provided to the time for time shift reproduction.

Third Modification to the First Embodiment

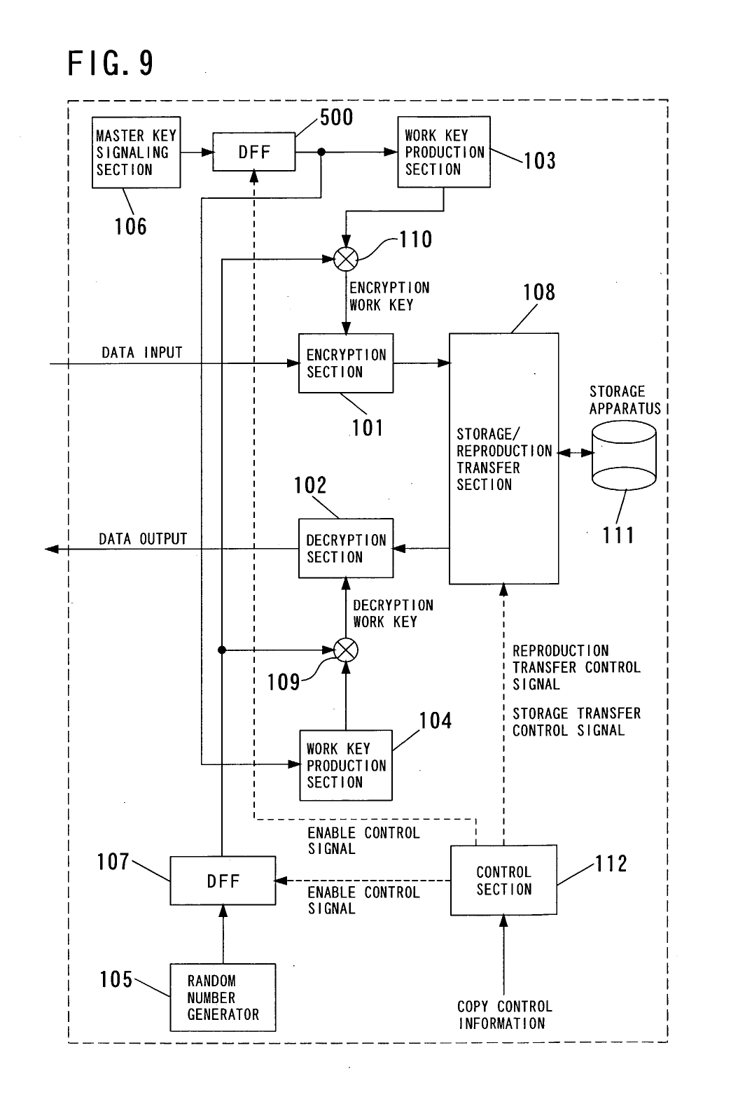

Referring now to FIG. 9, there is shown a still further time shift outputting apparatus to which the present invention is applied. The present time shift outputting apparatus is a modification to but is different from the time shift outputting apparatus of the first embodiment shown in FIG. 1 in that it additionally includes a delay flip-flop 500 interposed between the master key signaling section 106 and the work key production sections 103 and 104. In the following, description is given of the different feature.

The work key production section 103 performs a predetermined conversion process for a master key outputted from the delay flip-flop 500 to produce a work key from which an encryption work key is to be produced. The work key production section 104 performs a predetermined conversion process for the master key outputted from the delay flip-flop 500 to produce a work key from which a decryption work key is to be produced. The master key signaling section 106 outputs the master key from which work keys are to be produced to the delay flip-flop 500. The control section 112 controls the delay flip-flop 107, delay flip-flop 500 and storage/reproduction transfer section 108. In particular, the control section 112 controls them to encrypt and store input data into the storage apparatus 111 and read out and decrypt, after a time shift (delay) for predetermined time, the encrypted data from the storage apparatus 111 to realize “time shift outputting”. The delay flip-flop 500 latches the master key outputted from the master key signaling section 106 in response to an enable control signal from the control section 112.

Subsequently, description is given of action of the time shift outputting apparatus of the present modification when it performs, under the assumption that a data input thereto is stream data of a digital broadcast or the like, time shift reproduction for a particular program of the digital broadcast.

In this action, temporary storage for time shift reproduction is started at the top of a program 1 and reproduction is started after a time shift by arbitrary time, and the temporary storage and the time shift reproduction are ended at a point of time when the time shift reproduction is performed up to the last end of the program 1.

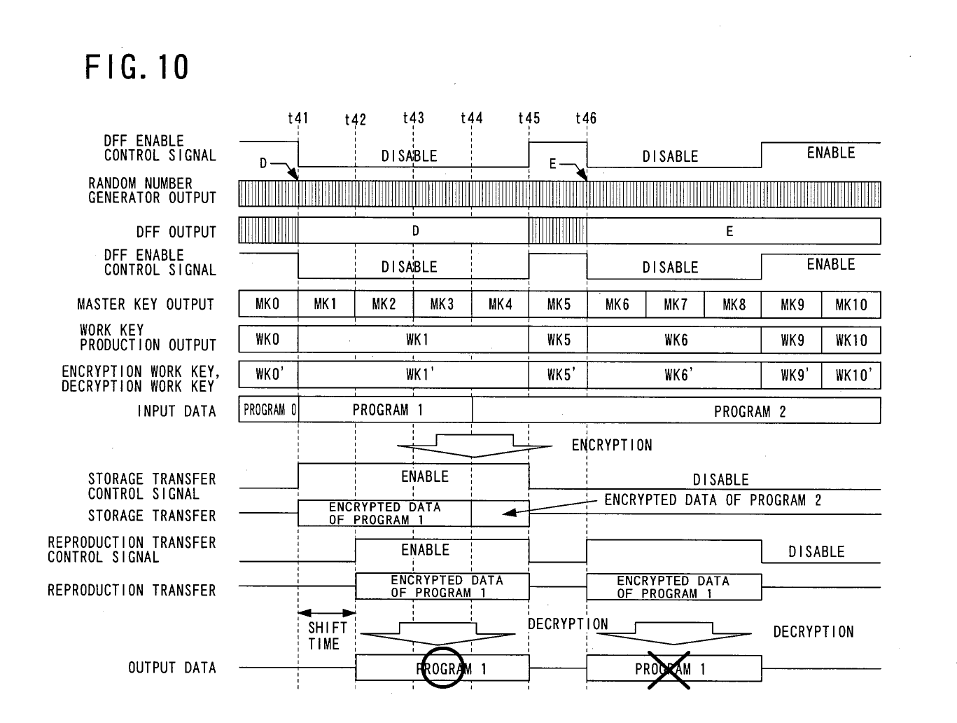

It is assumed that input data is formed from a time series of programs 0, 1 and 2 as seen in FIG. 10. Further, it is assumed that copy of data of the programs is inhibited in order to protect the copyright, but only temporary storage of the data is permitted.

The control section 112 sets the enable control signal for the delay flip-flop 107 as a disable signal at time t41 so that the delay flip-flop 107 latches an output of the random number generator 105. Here, it is assumed that a random value D (≠0) is latched into the delay flip-flop 107. Further, the control section 112 sets the enable control signal for the delay flip-flop 500 as a disable signal so that a master key output MK1 outputted at time t41 from the master key signaling section 106 is latched into the delay flip-flop 500. The work key production section 103 performs a predetermined conversion process for the master key output MK1 and outputs a resulting work key WK1.

Consequently, the exclusive OR gate 109 outputs an exclusive OR value WK1′ between the work key WK1 and the random number value D as an encryption work key.

The encryption section 101 uses the encryption work key WK1′ to encrypt the data of the program 1. The encoded data is stored into the storage apparatus 111 through the storage/reproduction transfer section 108. Such storage of the data into the storage apparatus 111 is executed by the control section 112 transmitting a “storage transfer control signal” representative of a valid state of storage transfer as an enable signal to the storage/reproduction transfer section 108. In other words, the control section 112 transmits the storage transfer control signal as an enable signal to the storage/reproduction transfer section 108 to store the encrypted data into the storage apparatus 111. Consequently, temporary storage is started at a starting point of time (t41) of the program 1.

When time shift outputting is started at time t42 after passage of an arbitrary period of shift time after the storage is started, the control section 112 controls the storage/reproduction transfer section 108 to store the encoded data of the program 1 into the storage apparatus 111 in a similar manner as described hereinabove and successively read out the encoded data of the program 1 stored in the storage apparatus 111 beginning with the top of the program 1. Such readout of the encoded data from the storage apparatus 111 is controlled by the control section 112 transmitting a “reproduction transfer control signal” representative of a valid state of reproduction transfer to the storage/reproduction transfer section 108 as an enable signal. In other words, the control section 112 transmits the reproduction transfer control signal as an enable signal to the storage/reproduction transfer section 108 to read out the encrypted data from the storage apparatus 111.

Thus, in this state, the control section 112 transmits the storage transfer control signal and the reproduction transfer control signal both as enable signals to the storage/reproduction transfer section 108.

At time t42, the work key production section 104 performs a predetermined conversion process for the master key MK1 latched in the delay flip-flop 500 and outputs a resulting work key WK1. Consequently, the exclusive OR gate 110 exclusively ORs the work key WK1 and the random number value D latched in the delay flip-flop 107 and outputs a resulting exclusive OR value WK1′ as a decryption work key at time t42.

The decryption section 102 uses the decryption work key WK1′ to decrypt the encrypted data of the program 1 acquired from the storage/reproduction transfer section 108. Since the work key used for the decryption is the same work key WK1′ as the work key used for the encryption, the encoded data of the program 1 is regenerated normally.

Also after the program 1 comes to an end (t44), the control section 112 continues to store the encrypted input data to the storage apparatus 111 through the storage/reproduction transfer section 108. In other words, also after the program 1 comes to an end, the control section 112 transmits the storage transfer control signal as an enable signal to the storage/reproduction transfer section 108. Consequently, the encrypted data of the program 2 is stored into the storage apparatus 111.

At a point of time (t45) at which the time shift reproduction is performed up to the end of the program 1, the control section 112 transmits the storage transfer control signal and the reproduction transfer control signal both as disable signals to the storage/reproduction transfer section 108. Consequently, the time shift reproduction apparatus ends the temporary storage and the time shift reproduction.

Further, the control section 112 sets the enable control signal for the delay flip-flop 500 to an enable signal so that the latched storage of the random number value D in the delay flip-flop 107 and the latched storage of the master key MK1 in the delay flip-flop 500 are cancelled. Consequently, after the time shift reproduction comes to an end, the work key WK1′ used then is disabled for further use.

Since the work key cannot be regenerated any more, the encrypted data of the program 1 stored in the storage apparatus 111 cannot be decrypted any more using a work key which coincides with the work key used for the encryption. Consequently, the encoded data stored in the storage apparatus 111 is invalidated and disabled from further use.

It is to be noted that the time shift outputting apparatus may be further modified such that, when a predetermined interval of time passes after temporary storage is started, the control section 112 transmits an enable signal to the delay flip-flop 107 and the delay flip-flop 500 so as to cancel the latched random value and the latched work key, respectively.

Here, it is assumed to try to reproduce the data of the program 1 temporarily stored and remaining in the storage apparatus 111 again at time t46 after the time shift reproduction comes to an end.

The control section 112 transmits the reproduction transfer control signal as an enable signal to the storage/reproduction transfer section 108. Further, the control section 112 transmits the enable control signal as a disable signal to the delay flip-flop 107 so that the delay flip-flop 107 latches an output (random number value E) of the random number generator 105. Furthermore, the control section 112 transmits the enable control signal as a disable signal to the delay flip-flop 500 so that the delay flip-flop 500 latches a master key MK6 signaled from the master key signaling section 106 at time t46. Consequently, the work key production section 103 performs a predetermined conversion process for the master key MK6 latched in the delay flip-flop 500 and outputs a resulting work key WK6.

The exclusive OR gate 110 exclusively ORs the work key WK6 and the random number value E and outputs a result of the exclusive ORing as a decryption work key. However, the decryption work key obtained here does not coincide with the encryption work key WK1′ used for the encryption of the data of the program 1. Consequently, even if the decryption work key is used to decrypt the encrypted data of the program 1, the data of the program 1 is not regenerated normally. In this manner, the encrypted data of the program 1 stored in the storage apparatus 111 is invalidated and cannot be reproduced after the time shift reproduction comes to an end.

Also with the time shift outputting apparatus of the present modification, temporarily stored data can be invalidated and disabled from further use after time shift reproduction thereof comes to an end, and besides advantages similar to those of the time shift outputting apparatus of the first embodiment can be anticipated.

Fourth Modification to the First Embodiment]

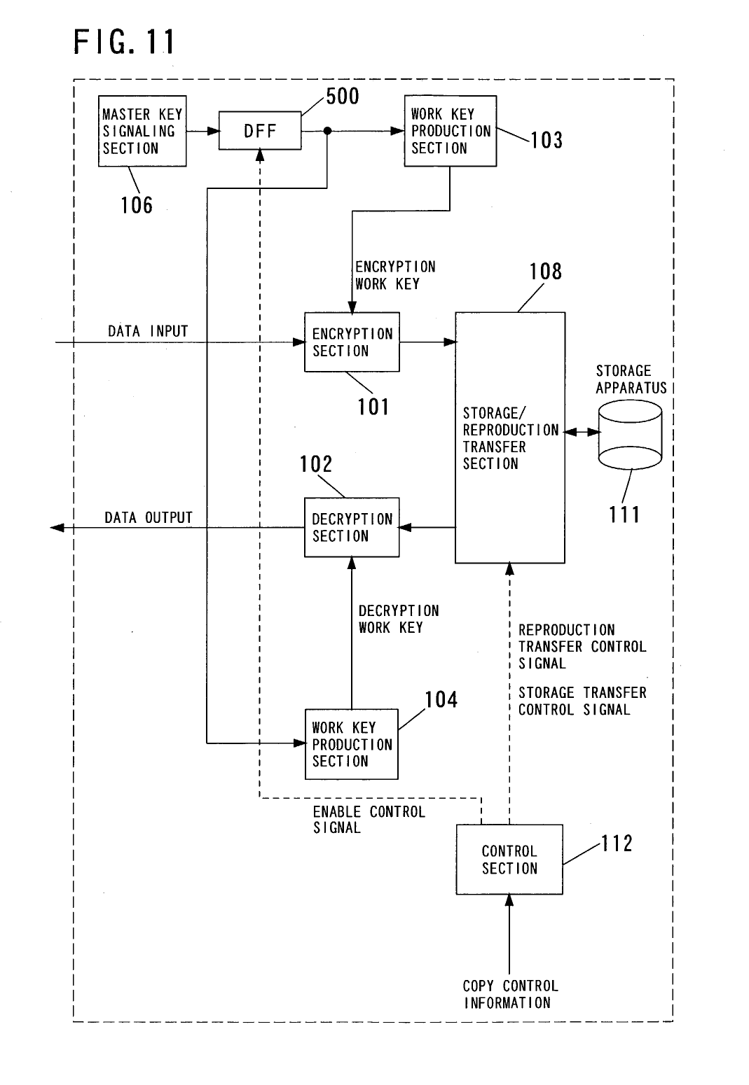

FIG. 11 shows a yet further time shift outputting apparatus to which the present invention is applied. The present time shift outputting apparatus is a modification to but is different from the time shift outputting apparatus of the fourth embodiment shown in FIG. 9 in that it eliminates the random number generator 105, delay flip-flop 107 and exclusive OR gates 109 and 110. In the following, description is given of the difference in configuration.

The work key production section 103 performs a predetermined conversion process for a master key outputted from the delay flip-flop 500 to produce an encryption work key. The work key production section 104 performs a predetermined conversion process for the master key outputted from the delay flip-flop 500 to produce a decryption work key. The master key signaling section 106 outputs a master key from which work keys are to be produced to the delay flip-flop 500. The control section 112 controls the delay flip-flop 500 and storage/reproduction transfer section 108. In particular, the control section 112 controls them to encrypt and store input data into the storage apparatus 111 and read out and decrypt, after a time shift (delay) for predetermined time, the encrypted data from the storage apparatus 111 to realize “time shift outputting”.

Subsequently, description is given of action of the time shift outputting apparatus of the present modification when it performs, under the assumption that a data input thereto is stream data of a digital broadcast or the like, time shift reproduction for a particular program of the digital broadcast.

In this action, temporary storage for time shift reproduction is started at the top of a program 1 and reproduction is started after a time shift by arbitrary time, and the temporary storage and the time shift reproduction are ended at a point of time when the time shift reproduction is performed up to the last end of the program 1.

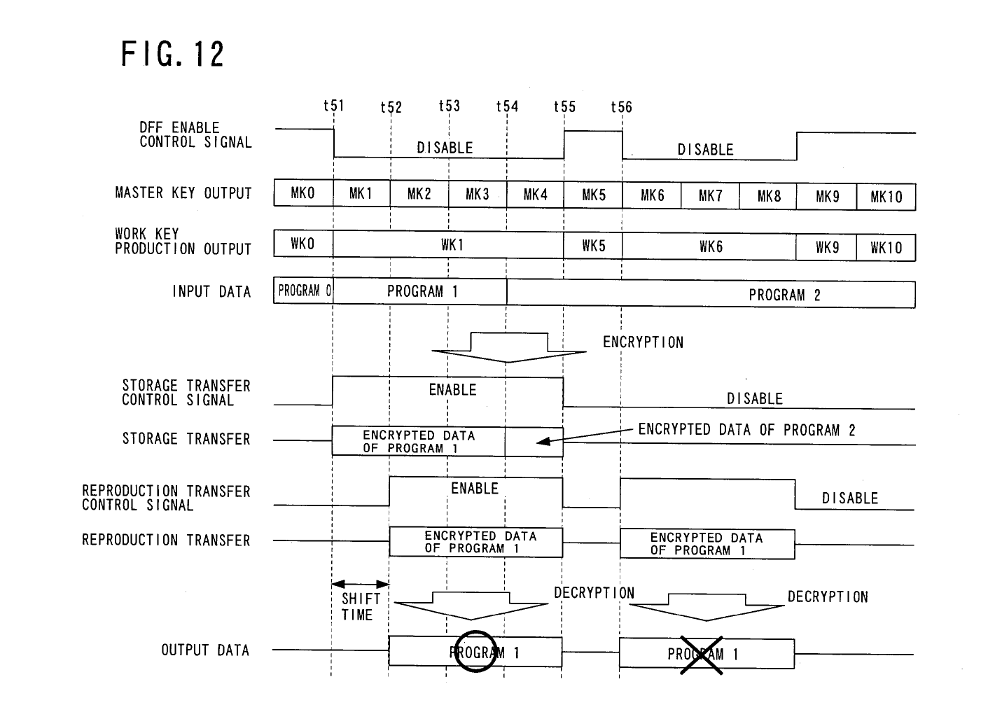

It is assumed that input data is formed from a time series of programs 0, 1 and 2 as seen in FIG. 12. Further, it is assumed that copy of data of the programs is inhibited in order to protect the copyright, but only temporary storage of the data is permitted.

The control section 112 sets the enable control signal for the delay flip-flop 500 as a disable signal at time t51 so that a master key output MK1 outputted at time t51 from the master key signaling section 106 is latched into the delay flip-flop 500. The work key production section 103 performs a predetermined conversion process for the master key output MK1 and outputs a resulting encryption work key WK1.

The encryption section 101 uses the encryption work key WK1 to encrypt the data of the program 1. The encoded data is stored into the storage apparatus 111 through the storage/reproduction transfer section 108. Such storage of the data into the storage apparatus 111 is executed by the control section 112 transmitting a “storage transfer control signal” representative of a valid state of storage transfer as an enable signal to the storage/reproduction transfer section 108. In other words, the control section 112 transmits the storage transfer control signal as an enable signal to the storage/reproduction transfer section 108 to store the encrypted data into the storage apparatus 111. Consequently, temporary storage is started at a starting point of time (t51) of the program 1.

When time shift outputting is started at time t52 after passage of an arbitrary period of shift time after the storage is started, the control section 112 controls the storage/reproduction transfer section 108 in a similar manner as described above to store the encoded data of the program 1 into the storage apparatus 111 and successively read out the encoded data of the program 1 stored in the storage apparatus 111 beginning with the top of the program 1. Such readout of the encoded data from the storage apparatus 111 is controlled by the control section 112 transmitting a “reproduction transfer control signal” representative of a valid state of reproduction transfer to the storage/reproduction transfer section 108 as an enable signal. In other words, the control section 112 transmits the reproduction transfer control signal as an enable signal to the storage/reproduction transfer section 108 to read out the encrypted data from the storage apparatus 111.

Thus, in this state, the control section 112 transmits the storage transfer control signal and the reproduction transfer control signal both as enable signals to the storage/reproduction transfer section 108.

At time t52, the work key production section 104 performs a predetermined conversion process for the master key MK1 latched in the delay flip-flop 500 and outputs a resulting decryption work key WK1.

The decryption section 102 uses the decryption work key WK1 to decrypt the encrypted data of the program 1 acquired from the storage/reproduction transfer section 108. Since the work key used for the decryption is the same work key WK1 as the work key used for the encryption, the encoded data of the program 1 is regenerated normally.

Also after the program 1 comes to an end (t54), the control section 112 stores the encrypted input data to the storage apparatus 111 through the storage/reproduction transfer section 108. In other words, also after the program 1 comes to an end, the control section 112 transmits the storage transfer control signal as an enable signal to the storage/reproduction transfer section 108. Consequently, the encrypted data of the program 2 is stored into the storage apparatus 111.

At a point of time (t55) at which the time shift reproduction is performed up to the end of the program 1, the control section 112 transmits the storage transfer control signal and the reproduction transfer control signal both as disable signals to the storage/reproduction transfer section 108. Consequently, the time shift reproduction apparatus ends the temporary storage and the time shift reproduction.

Further, the control section 112 sets the enable control signal for the delay flip-flop 500 to an enable signal so that the latched storage of the master key MK1 in the delay flip-flop 500 is cancelled. Consequently, after the time shift reproduction comes to an end, the work key WK1 used then is disabled for further use.

Since the work key cannot be regenerated any more, the encrypted data of the program 1 stored in the storage apparatus 111 cannot be decrypted any more using a work key which coincides with the work key used for the encryption. Consequently, the encoded data stored in the storage apparatus 111 is invalidated and disabled from further use.

It is to be noted that the time shift outputting apparatus may be further modified such that, when a predetermined interval of time passes after temporary storage is started, the control section 112 transmits an enable signal to the delay flip-flop 500 so as to cancel the latched random value and the latched work key.

Here, it is assumed to try to reproduce the data of the program 1 temporarily stored and remaining in the storage apparatus 111 again at time t56 after the time shift reproduction comes to an end.

The control section 112 transmits the reproduction transfer control signal as an enable signal to the storage/reproduction transfer section 108. Further, the control section 112 transmits the enable control signal as a disable signal to the delay flip-flop 500 so that the delay flip-flop 500 latches a master key MK6 signaled from the master key signaling section 106 at time t56.

The work key production section 103 performs a predetermined conversion process for the master key MK6 latched in the delay flip-flop 500 and outputs a resulting work key WK6. However, the decryption work key obtained here does not coincide with the encryption work key WK1 used for the encryption of the data of the program 1. Consequently, even if the decryption work key is used to decrypt the encrypted data of the program 1, the data of the program 1 is not regenerated normally. In this manner, the encrypted data of the program 1 stored in the storage apparatus 111 is invalidated and cannot be reproduced after the time shift reproduction comes to an end.

Also with the time shift outputting apparatus of the present modification, temporarily stored data can be invalidated and disabled from further use after time shift reproduction thereof comes to an end, and besides advantages similar to those of the time shift outputting apparatus of the first embodiment can be anticipated.

Second Embodiment

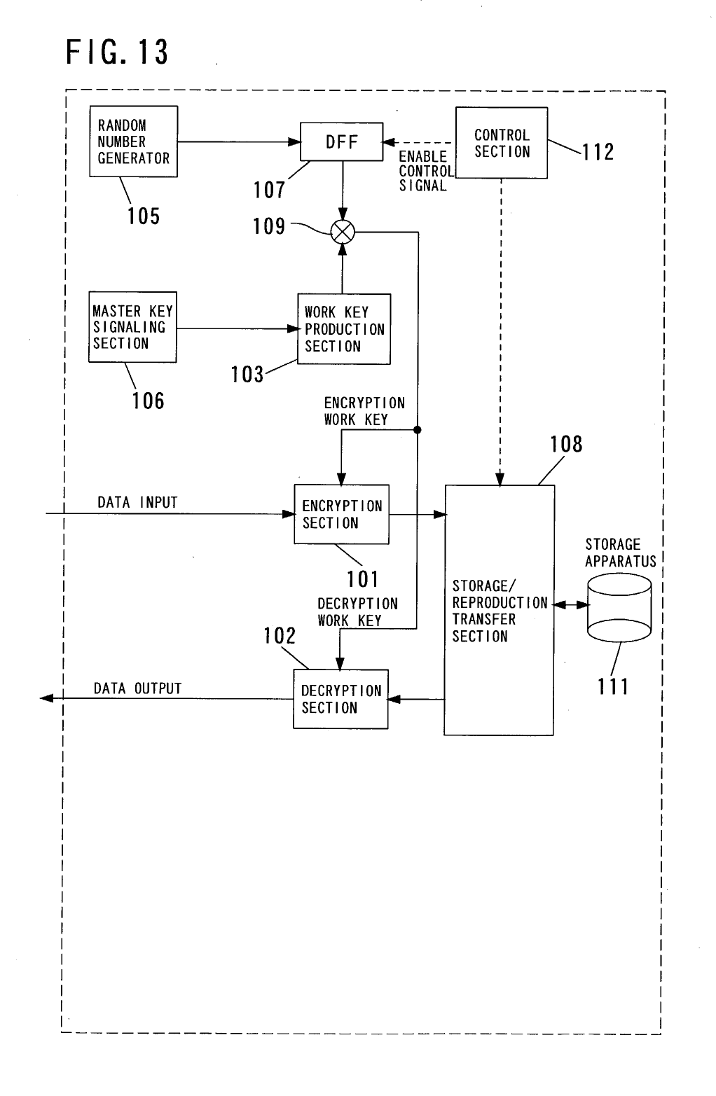

FIG. 13 shows a yet further time shift outputting apparatus to which the present invention is applied. The present time shift outputting apparatus includes an encryption section 101, a decryption section 102, a work key production section 103, a random number generator 105, a master key signaling section 106, a delay flip-flop 107, a storage/reproduction transfer section 108, an exclusive OR gate 109, a storage apparatus 111 and a control section 112.

The work key production section 103 performs a predetermined conversion process for a master key signaled from the master key signaling section 106 to produce a work key from which an encryption work key and a decryption work key are to be produced. The master key signaling section 106 outputs the master key on which the work keys are to be based to the work key production section 103. The exclusive OR gate 109 exclusively ORs the work key produced by the work key production section 103 and a random number value outputted from the delay flip-flop 107 for individual bits and outputs a result of the exclusive ORing as an encryption work key and a decryption work key.

The other components of the time shift outputting apparatus of the present embodiment operate similarly to those of the time shift outputting apparatus of the first embodiment described above.

The time shift outputting apparatus of the present embodiment is an equivalent system to the time shift outputting apparatus of the first embodiment and can invalidate and disable, through the similar operation described above, temporarily stored data from use after the time shift reproduction of the stored data comes to an end.

While similar advantages to those of the time shift outputting apparatus of the first embodiment can be achieved with the time shift outputting apparatus of the present embodiment, the time shift outputting apparatus of the present embodiment can be simplified in configuration.

Third Embodiment

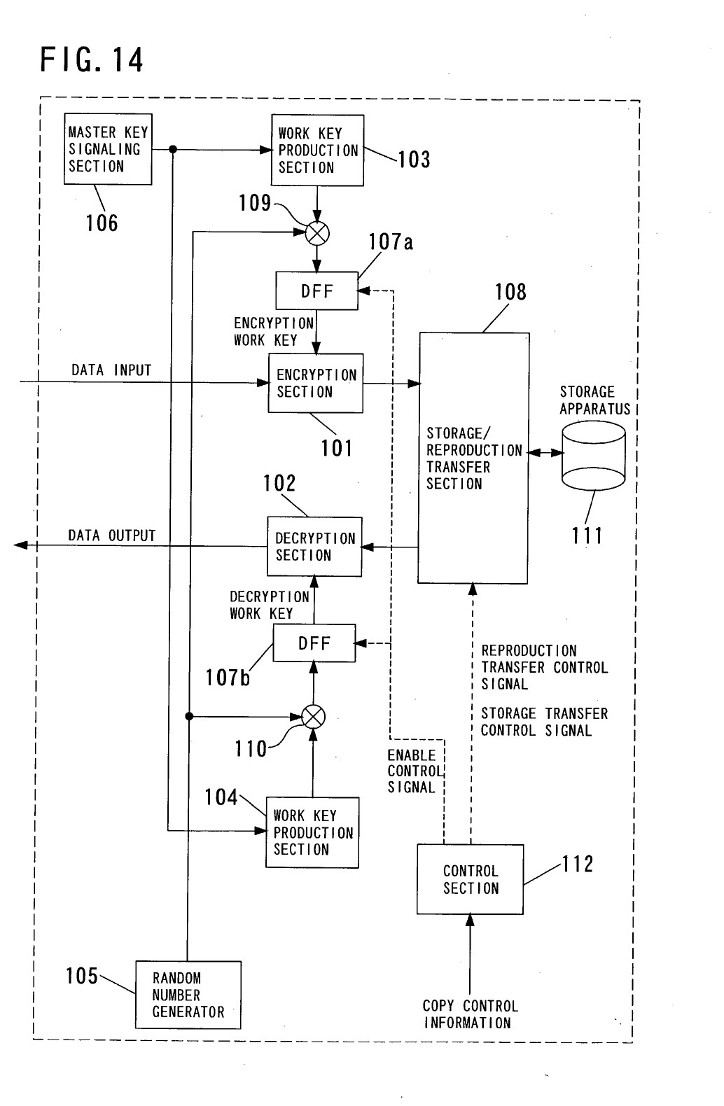

FIG. 14 shows a yet further time shift outputting apparatus to which the present invention is applied. The time shift outputting apparatus of the present embodiment includes an encryption section 101, a decryption section 102, a pair of work key production sections 103 and 104, a random number generator 105, a master key signaling section 106, a pair of delay flip-flops 107a and 107b, a storage/reproduction transfer section 108, a pair of exclusive OR gates 109 and 110, a storage apparatus 111 and a control section 112.

The delay flip-flop 107a latches an encryption work key outputted from the exclusive OR gate 109 in accordance with an enable control signal from the control section 112. The delay flip-flop 107b latches a decryption work key outputted from the exclusive OR gate 110 in accordance with the enable control signal from the control section 112. The control section 112 controls the delay flip-flops 107a and 107b and storage/reproduction transfer section 108. In other words, the control section 112 controls them to encrypt and store input data into the storage apparatus 111 and read out and decrypt the data from the storage apparatus 111 after a shift or delay of a predetermined interval of time to realize “time shift outputting”.

The other components of the time shift outputting apparatus of the present embodiment operate similarly to those of the time shift outputting apparatus of the first embodiment described hereinabove.

Subsequently, description is given of action of the time shift outputting apparatus of the present embodiment when it performs, under the assumption that a data input thereto is stream data of a digital broadcast or the like, time shift reproduction for a particular program of the digital broadcast.

In this action, temporary storage for time shift reproduction is started at the top of a program 1 and reproduction is started after a time shift by arbitrary time, and the temporary storage and the time shift reproduction are ended at a point of time when the time shift reproduction is performed up to the last end of the program 1.

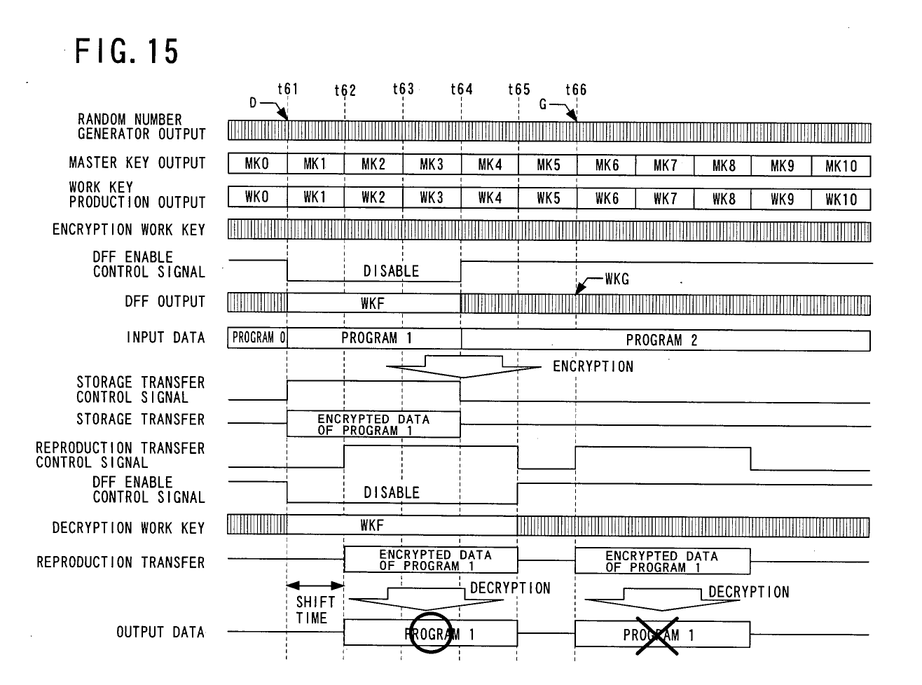

It is assumed that input data is formed from a time series of programs 0, 1 and 2 as seen in FIG. 15. Further, it is assumed that copy of data of the programs is inhibited in order to protect the copyright, but only temporary storage of the data is permitted.

It is to be noted that, for simplified description, it is assumed that each of the work key production sections 103 and 104 always output the same work key.

At time t61, each of the work key production sections 103 and 104 performs a predetermined conversion process for a master key MK1 signaled from the master key signaling section 106 and outputs a resulting work key WK1. Consequently, if the random value outputted from the random number generator 105 at time t61 is F, then each of the exclusive OR gates 109 and 110 outputs an exclusive OR value WKF of the random number value F and the work key WK1.

Consequently, if the control section 112 sets the enable control signal for the delay flip-flop 107a as a disable signal, then the delay flip-flop 107a latches the exclusive OR value WKF outputted from the exclusive OR gate 109. The exclusive OR value latched by the delay flip-flop 107a is outputted as an encryption work key.

The encryption section 101 uses the encryption work key WKF to encrypt the data of the program 1. The encoded data is stored into the storage apparatus 111 through the storage/reproduction transfer section 108. Such storage of the data into the storage apparatus 111 is executed by the control section 112 transmitting a “storage transfer control signal” representative of a valid state of storage transfer as an enable signal to the storage/reproduction transfer section 108. In other words, the control section 112 transmits the storage transfer control signal as an enable signal to the storage/reproduction transfer section 108 to store the encrypted data into the storage apparatus 111. Consequently, temporary storage is started at a starting point of time (t61) of the program 1.

Further, at time t61, the control section 112 sends the enable control signal as a disable signal also to the delay flip-flop 107b so that the delay flip-flop 107b latches the exclusive OR value WKF from the exclusive OR gate 110.

When time shift outputting is started at time t62 after passage of an arbitrary period of shift time after the storage is started, the control section 112 controls the storage/reproduction transfer section 108 to store the encoded data of the program 1 into the storage apparatus 111 and successively read out the encoded data of the program 1 stored in the storage apparatus 111 beginning with the top of the program 1. Such readout of the encoded data from the storage apparatus 111 is controlled by the control section 112 transmitting a reproduction transfer control signal as an enable signal to the storage/reproduction transfer section 108. Thus, in this state, the control section 112 transmits the storage transfer control signal and the reproduction transfer control signal both as enable signals to the storage/reproduction transfer section 108.

At time t62, the value WKF latched in the delay flip-flop 107b is outputted as a decryption work key. Consequently, the decryption section 102 uses the decryption work key WKF to decrypt the encrypted data of the program 1 acquired from the storage/reproduction transfer section 108. Since the work key used for the decryption is the same work key WKF as the work key used for the encryption, the encoded data of the program 1 is regenerated normally.

After the program 1 comes to an end (t64), the control section 112 sends the enable control signal as an enable signal to the delay flip-flop 107a so that the latched value WKF of the delay flip-flop 107a is canceled. Further, the control section 112 transmits the storage transfer control signal as a disable signal to the storage/reproduction transfer section 108 to end the temporary storage.

At a point of time (t65) at which the time shift reproduction is performed up to the end of the program 1, the control section 112 transmits the reproduction transfer control signal as a disable signal to the storage/reproduction transfer section 108. Consequently, the time shift reproduction apparatus ends the time shift reproduction.

Further, the control section 112 sets the enable control signal for the delay flip-flop 500 to an enable signal so that the latched storage of the latched value WKF in the delay flip-flop 107b is cancelled. Consequently, after the time shift reproduction comes to an end, the work key WKF′ used then is disabled for further use. In other words, by making it impossible to regenerate the random number value from which a work key is to be produced, it becomes impossible to regenerate the work key itself.

It is to be noted that the time shift outputting apparatus may be further modified such that, when a predetermined interval of time passes after temporary storage is started, the control section 112 transmits an enable signal to the delay flip-flop 107b so as to cancel the latched work key WKF.

Here, it is assumed to try to reproduce the data of the program 1 temporarily stored and remaining in the storage apparatus 111 again after the time shift reproduction comes to an end.

When it is tried to reproduce the encoded data of the program 1 stored in the storage apparatus 111 again at time t66 after the time shift reproduction comes to an end, the control section 112 transmits the reproduction transfer control signal as an enable signal to the storage/reproduction transfer section 108.

It is assumed that a random number value G is outputted from the random number generator 105 at time t66. Since the work key production section 104 outputs work key WK6 at this point of time, the exclusive OR gate 110 outputs an exclusive OR value WKG of the random number value G and the work key WK6. The decryption work key WKG obtained here does not coincide with the encryption work key WKF used for the encryption of the data of the program. Consequently, even if the exclusive OR value WKG is used as a decryption work key to decrypt the encrypted data of the program 1, the data of the program 1 is not regenerated normally. Consequently, the encoded data of the program 1 stored in the storage apparatus 111 is invalidated and disabled from regeneration.

Also with the time shift outputting apparatus of the present embodiment, temporarily stored data can be invalidated and disabled from further use after time shift reproduction thereof comes to an end, and besides advantages similar to those of the time shift outputting apparatus of the first embodiment can be anticipated.

It is to be noted that the embodiments described above are mere examples in embodying the present invention and the present invention is not limited to them.

For example, while, in the embodiments and the modifications described above, it is possible to regenerate data if the same work key is used for encryption and decryption, the encryption work key and the decryption work key need not necessarily be the same as each other. In other words, the encryption work key and the decryption work key may be different from each other only if they make a combination with which encrypted data can be regenerated correctly.

Further, the function for periodically changing the work keys need not necessarily be a one-way function. However, use of a one-way function is preferable because it raises the key secrecy.

In this manner, the prevent invention can be carried out in various forms.

What is claimed is:

1. A time shift outputting method, comprising:
a key retaining step of retaining an encryption key, which varies as time passes, at an arbitrary timing;
a step of encrypting data of contents using the encryption key retained at the key retaining step to produce encrypted data;
a step of storing the encrypted data into storage means;
a readout step of reading out the encrypted data stored in said storage means when predetermined time passes after the encrypted data is stored;
a step of decrypting the encrypted data read out at the readout step using the encryption key retained at the key retaining step; and
a step of canceling the retention of the encryption key after the decryption of the encrypted data of the contents ends.

2. A time shift outputting method as claimed in claim 1, wherein the retention of the encryption key is canceled when predetermined time passes after the storage of the encrypted data of the contents into the storage means is started.

3. A time shift outputting method as claimed in claim 1, wherein the retention of the encryption key is canceled when predetermined time passes after the storage of the encrypted data of the contents into the storage means ends.

4. A time shift outputting method as claimed in claim 1, wherein at least part of the encryption key varies as time passes.

5. A time shift outputting method, comprising:
a random number retaining step of retaining a random number value, which varies as time passes, at an arbitrary timing;
a step of changing a master encryption key using the random number value retained at the random number retaining step to produce a work encryption key;
a step of encrypting data of contents using the work encryption key to produce encrypted data;
a step of storing the encrypted data into storage means;
a readout step of reading out the encrypted data stored in said storage means when predetermined time passes after the encrypted data is stored;
a step of decrypting the encrypted data read out at the readout step using the work encryption key; and
a step of canceling the retention of the random number value after the decryption of the encrypted data of the contents ends.

6. A time shift outputting method as claimed in claim 5, wherein the retention of the random number value retained at the random number retaining step is cancelled when predetermined time passes after the storage of the encrypted data of the contents into said storage means is started.

7. A time shift outputting method as claimed in claim 5, wherein the retention of the random number value retained at the random number retaining step is cancelled when predetermined time passes after the storage of the encrypted data of the contents into said storage means ends.

8. A time shift outputting method, comprising:
a random number retaining step of retaining a random number value, which varies as time passes, at an arbitrary timing;
a step of changing a master encryption key using the random number value retained at the random number retaining step to produce an encryption key;
a step of encrypting data of contents using the encryption key to produce encrypted data;
a step of storing the encrypted data into storage means;
a readout step of reading out the encrypted data stored in the storage means when predetermined time passes after the encrypted data is stored;
a step of changing the master encryption key using the random number value retained at the random number retaining step to produce a decryption key;
a step of decrypting the encrypted data read out at the readout step using the decryption key; and
a step of canceling the retention of the random number value retained at the random number retaining step after the decryption of the encrypted data of the contents ends.

9. A time shift outputting method as claimed in claim 8, wherein the retention of the random number value retained at the random number retaining step is cancelled when predetermined time passes after the storage of the encrypted data of the contents into said storage means is started.

10. A time shift outputting method as claimed in claim 8, wherein the retention of the random number value retained at the random number retaining step is cancelled when predetermined time passes after the storage of the encrypted data of the contents into said storage means ends.

11. A time shift outputting method, comprising:
a random number retaining step of retaining a random number value, which varies as time passes, at an arbitrary timing;
a step of encoding data of contents using the random number value retained at the random number retaining step to produce encrypted data;
a step of storing the encrypted data into storage means;
a readout step of reading out the encrypted data stored in said storage means when predetermined time passes after the encrypted data is stored;
a step of decrypting the encrypted data read out at the readout step using the random number value retained at the random number retaining step; and
a step of canceling the retention of the random number value retained at the random number retaining step after the decryption of the encrypted data of the contents ends.

12. A time shift outputting method as claimed in claim 11, wherein the retention of the random number value retained at the random number retaining step is cancelled when predetermined time passes after the storage of the encrypted data of the contents into said storage means is started.

13. A time shift outputting method as claimed in claim 11, wherein the retention of the random number value retained at the random number retaining step is cancelled when predetermined time passes after the storage of the encrypted data of the contents into said storage means ends.

14. A time shift outputting method, comprising:
a random number retaining step of retaining a random number value, which varies as time passes, at an arbitrary timing;
a step of calculating the random number value retained at the random number retaining step with a one-way function by a predetermined number of times to produce an initial random number value;
a step of calculating the initial random number value with the one-way function by the predetermined number of times to produce an encrypting random number value;
a step of changing a master encryption key using the encrypting random number value to produce an encryption key;
a step of encrypting data of contents using the encryption key to produce encrypted data;
a step of storing the encrypted data into storage means;
a readout step of reading out the encrypted data stored in said storage means when predetermined time passes after the encrypted data is stored;
a step of calculating the initial random number value with the one-way function by the predetermined number of times to produce a decrypting random number value;
a step of changing the master encryption key using the decrypting random number value to produce a decryption key;
a step of decrypting the encrypted data read out at the readout step using the decryption key; and
a step of canceling the retention of the random number value retained at the random number retaining step after the decryption of the encrypted data of the contents ends.

15. A time shift outputting method as claimed in claim 14, wherein the initial random number value is a value obtained by calculating the random number value retained at random number retaining step with the one-way function at intervals of passage of predetermined time after starting of the storage of the encrypted data of the contents into said storage means.

16. A time shift outputting step as claimed in claim 14, wherein the number of times of the calculation of the initial random number value with the one-way function for producing a decrypting random number value is set in response to an interval of time after the encrypted data of the contents is stored into said storage means until the encrypted data of the contents is read out at the readout step.

17. A time shift outputting method as claimed in claim 14, wherein the retention of the random number value retained at the random number retaining step is cancelled when predetermined time passes after the storage of the encrypted data of the contents into said storage means is started.

18. A time shift outputting method as claimed in claim 14, wherein the retention of the random number value retained at the random number retaining step is cancelled when predetermined time passes after the storage of the encrypted data of the contents into said storage means ends.

19. A time shift outputting method, comprising:
a random number retaining step of retaining a random number value, which varies as time passes, at an arbitrary timing;
a master encryption key retaining step of retaining a master encryption key, which varies as time passes, at an arbitrary timing;
a step of changing the master encryption key retained at the master encryption key retaining step using the random number value retained at the random number retaining step to produce a work encryption key;
a step of encrypting data of contents using the work encryption key to produce encrypted data;
a step of storing the encrypted data into storage means;
a readout step of reading out the encrypted data stored in said storage means when predetermined time passes after the encrypted data is stored;
a step of decrypting the encrypted data read out at the readout step using the work encryption key; and
a step of canceling at least any one of the retentions of the random number value retained at the random number retaining step and the master encryption key retained at the master encryption key retaining step after the decryption of the encrypted data of the contents ends.

20. A time shift outputting method as claimed in claim 19, wherein the retention of the master encryption key is cancelled when predetermined time passes after the storage of the encrypted data of the contents into said storage means is started.

21. A time shift outputting method as claimed in claim 19, wherein the retention of the master encryption key is cancelled when predetermined time passes after the storage of the encrypted data of the contents into said storage means ends.

22. A time shift outputting method as claimed in claim 19, wherein at least part of the master encryption key varies as time passes.

23. A time shift outputting method as claimed in claim 19, wherein the retention of the random number value retained at the random number retaining step is cancelled when predetermined time passes after the storage of the encrypted data of the contents into said storage means is started.

24. A time shift outputting method as claimed in claim 19, wherein the retention of the random number value retained at the random number retaining step is cancelled when predetermined time passes after the storage of the encrypted data of the contents into said storage means ends.

25. A time shift outputting method, comprising:
a random number retaining step of retaining a random number value, which varies as time passes, at an arbitrary timing;
a master encryption key retaining step of retaining a master encryption key, which varies as time passes, at an arbitrary timing;
a step of changing the master encryption key retained at the master encryption key retaining step using the random number value retained at the random number retaining step to produce an encryption key;
a step of encrypting data of contents using the encryption key to produce encrypted data;
a step of storing the encrypted data into storage means;
a readout step of reading out the encrypted data stored in said storage means when predetermined time passes after the encrypted data is stored;
a step of changing the master encryption key retained at the master encryption key retaining step using the random number value retained at the random number retaining step to produce a decryption key;
a step of decrypting the encrypted data read out at the readout step using the decryption key; and
a step of canceling at least any one of the retentions of the random number value retained at the random number retaining step and the master encryption key retained at the master encryption key retaining step after the decryption of the encrypted data of the contents ends.

26. A time shift outputting method as claimed in claim 25, wherein the retention of the master encryption key is cancelled when predetermined time passes after the storage of the encrypted data of the contents into said storage means is started.

27. A time shift outputting method as claimed in claim 25, wherein the retention of the master encryption key is cancelled when predetermined time passes after the storage of the encrypted data of the contents into said storage means ends.

28. A time shift outputting method as claimed in claim 25, wherein at least part of the master encryption key varies as time passes.

29. A time shift outputting method as claimed in claim 25, wherein the retention of the random number value retained at the random number retaining step is cancelled when predetermined time passes after the storage of the encrypted data of the contents into said storage means is started.

30. A time shift outputting method as claimed in claim 25, wherein the retention of the random number value retained at the random number retaining step is cancelled when predetermined time passes after the storage of the encrypted data of the contents into said storage means ends.

31. A time shift outputting method, comprising:
a step of changing a master encryption key using a random number value, which varies as time passes, to produce a work encryption key;
a work encryption key retaining step of retaining the work encryption key at an arbitrary timing;
a step of encrypting data of contents using the work encryption key retained at the work encryption key retaining step to produce encrypted data;
a step of storing the encrypted data into storage means;
a readout step of reading out the encrypted data stored in said storage means when predetermined time passes after the encrypted data is stored;
a step of decrypting the encrypted data read out at the readout step using the work encryption key retained at the work encryption key retaining step; and
a step of canceling the retention of the work encryption key after the decryption of the encrypted data of the contents ends.

32. A time shift outputting method as claimed in claim 31, wherein the retention of the work encryption key is cancelled when predetermined time passes after the storage of the encrypted data of the contents into said storage means is started.

33. A time shift outputting method as claimed in claim 31, wherein the retention of the work encryption key is cancelled when predetermined time passes after the storage of the encrypted data of the contents into said storage means ends.

34. A time shift outputting method, comprising:
a step of changing a master encryption key, which varies as time passes, using a random number value, which varies as time passes, to produce a work encryption key;
a work encryption key retaining step of retaining the work encryption key at an arbitrary timing;
a step of encrypting data of contents using the work encryption key retained at the work encryption key retaining step to produce encrypted data;
a step of storing the encrypted data into storage means;
a readout step of reading out the encrypted data stored in said storage means when predetermined time passes after the encrypted data is stored;
a step of decrypting the encrypted data read out at the readout step using the work encryption key retained at the work encryption key retaining step; and
a step of canceling the retention of the work encryption key after the decryption of the encrypted data of the contents ends.

35. A time shift outputting method as claimed in claim 34, wherein at least part of the master encryption key varies as time passes.

36. A time shift outputting method as claimed in claim 34, wherein the retention of the work encryption key is cancelled when predetermined time passes after the storage of the encrypted data of the contents into said storage means is started.

37. A time shift outputting method as claimed in claim 34, wherein the retention of the work encryption key is cancelled when predetermined time passes after the storage of the encrypted data of the contents into said storage means ends.

38. A time shift outputting apparatus, comprising:
key changing means for changing an encryption key as time passes;
key retaining means for retaining the encryption key at an arbitrary timing;
means for encrypting data of contents using the encryption key retained by said key retaining means to produce encrypted data;
storage means for storing the encrypted data;
readout means for reading out the encrypted data stored in said storage means when predetermined time passes after the encrypted data is stored;
means for decrypting the encrypted data read out by said readout means using the encryption key retained by said key retaining means; and
means for canceling the retention of the encryption key after the decryption of the encrypted data of the contents ends.

39. A time shift outputting apparatus as claimed in claim 38, further comprising means for canceling the retention of the encryption key when predetermined time passes after the storage of the encrypted data of the contents into said storage means is started.

40. A time shift outputting apparatus as claimed in claim 38, further comprising means for canceling the retention of the encryption key when predetermined time passes after the storage of the encrypted data of the contents into said storage means ends.

41. A time shift outputting apparatus as claimed in claim 38, wherein said key changing means changes at least part of the encryption key as time passes.

42. A time shift outputting apparatus, comprising:
random number generating means for generating a random number value which varies as time passes;
random number value retaining means for retaining the random number value generated by said random number generating means at an arbitrary timing;
means for changing a master encryption key using the random number value retained by said random number value retaining means to produce a work encryption key;
means for encrypting data of contents using the work encryption key to produce encrypted data;
means for storing the encrypted data;
readout means for reading out the encrypted data stored in said storage means when predetermined time passes after the encrypted data is stored;
means for decrypting the encrypted data read out by said readout means using the work encryption key; and
means for canceling the retention of the random number value after the decryption of the encrypted data of the contents ends.

43. A time shift outputting apparatus as claimed in claim 42, further comprising means for canceling the retention of the random number value retained by said random number retaining means when predetermined time passes after the storage of the encrypted data of the contents into said storage means is started.

44. A time shift outputting apparatus as claimed in claim 42, further comprising means for canceling the retention of the random number value retained by said random number retaining means when predetermined time passes after the storage of the encrypted data of the contents into said storage means ends.

45. A time shift outputting apparatus, comprising:
random number generating means for generating a random number value which varies as time passes;
random number value retaining means for retaining the random number value generated by said random number generating means at an arbitrary timing;
means for changing a master encryption key using the random number value retained by said random number value retaining means to produce an encryption key;
means for encrypting data of contents using the encryption key to produce encrypted data;
means for storing the encrypted data;
readout means for reading out the encrypted data stored in said storage means when predetermined time passes after the encrypted data is stored;
means for changing the master encryption key using the random number value retained by said random number value retaining means to produce a decryption key;
means for decrypting the encrypted data read out by said readout means using the decryption key; and
means for canceling the retention of the random number value retained by said random number value retaining means after the decryption of the encrypted data of the contents ends.

46. A time shift outputting apparatus as claimed in claim 45, further comprising means for canceling the retention of the random number value retained by said random number retaining means when predetermined time passes after the storage of the encrypted data of the contents into said storage means is started.

47. A time shift outputting apparatus as claimed in claim 45, further comprising means for canceling the retention of the random number value retained by said random number retaining means when predetermined time passes after the storage of the encrypted data of the contents into said storage means ends.

48. A time shift outputting apparatus, comprising:
random number generating means for generating a random number value which varies as time passes;
random number value retaining means for retaining the random number value generated by said random number generating means at an arbitrary timing;
means for encrypting data of contents using the random number value retained by said random number value retaining means to produce encrypted data;
means for storing the encrypted data;
readout means for reading out the encrypted data stored in said storage means when predetermined time passes after the encrypted data is stored;
means for decrypting the encrypted data read out by said readout means using the random number value retained by said random number value retaining means; and
means for canceling the retention of the random number value retained by said random number value retaining means after the decryption of the encrypted data of the contents ends.

49. A time shift outputting apparatus as claimed in claim 48, further comprising means for canceling the retention of the random number value retained by said random number retaining means when predetermined time passes after the storage of the encrypted data of the contents into said storage means is started.

50. A time shift outputting apparatus as claimed in claim 48, further comprising means for canceling the retention of the random number value retained by said random number retaining means when predetermined time passes after the storage of the encrypted data of the contents into said storage means ends.

51. A time shift outputting apparatus, comprising:
random number generating means for generating a random number value which varies as time passes;
random number value retaining means for retaining the random number value generated by said random number generating means at an arbitrary timing;
means for calculating the random number value retained by said random number value retaining means with a one-way function by a predetermined number of times to produce an encrypting random number value;
means for changing the master encryption key using the encrypting random number value to produce an encryption key;
means for encrypting data of contents using the encryption key to produce encrypted data;
means for storing the encrypted data;
readout means for reading out the encrypted data stored in said storage means when predetermined time passes after the encrypted data is stored;
means for calculating the random number value retained by said random number value retaining means with the one-way function by the predetermined number of times to produce a decrypting random number value;
means for changing the master encryption key using the decrypting random number value to produce a decryption key;
means for decrypting the encrypted data read out by said readout means using the decryption key; and
means for canceling the retention of the random number value retained by said random number value retaining means after the decryption of the encrypted data of the contents ends.

52. A time shift outputting apparatus as claimed in claim 51, wherein the random number value is a value obtained by calculating the random number value retained by said random number value retaining means with the one-way function every time predetermined time passes after starting of the storage of the encrypted data of the contents into said storage means.

53. A time shift outputting apparatus as claimed in claim 51, wherein the number of times of the calculation of the random number value retained by said random number value retaining means with the one-way function for producing the encrypting random number value is set in response to an interval of time after the encrypted data of the contents is stored into said storage means until the encrypted data of the contents is read out by said readout means.

54. A time shift outputting apparatus as claimed in claim 51, further comprising means for canceling the retention of the random number value retained by said random number retaining means when predetermined time passes after the storage of the encrypted data of the contents into said storage means is started.

55. A time shift outputting apparatus as claimed in claim 51, further comprising means for canceling the retention of the random number value retained by said random number retaining means when predetermined time passes after the storage of the encrypted data of the contents into said storage means ends.

56. A time shift outputting apparatus, comprising:
random number generating means for generating a random number value which varies as time passes;
random number value retaining means for retaining the random number value generated by said random number generating means at an arbitrary timing;
master encryption key producing means for producing a master encryption key which varies as time passes;
master encryption key retaining means for retaining the master encryption key produced by said master encryption key producing means at an arbitrary timing;
means for changing the master encryption key retained by said master encryption key retaining means using the random number value retained by said random number value retaining means to produce a work encryption key;
means for encrypting data of contents using the work encryption key to produce encrypted data;
means for storing the encrypted data;
readout means for reading out the encrypted data stored in said storage means when predetermined time passes after the encrypted data is stored;
means for decrypting the encrypted data read out by said readout means using the work encryption key; and
means for canceling at least any one of the retentions of the random number value retained by said random number value retaining means and the master encryption key retained by said master encryption key retaining means after the decryption of the encrypted data of the contents ends.

57. A time shift outputting apparatus as claimed in claim 56, further comprising means for canceling the retention of the master encryption key when predetermined time passes after the storage of the encrypted data of the contents into said storage means is started.

58. A time shift outputting apparatus as claimed in claim 56, further comprising means for canceling the retention of the master encryption key when predetermined time passes after the storage of the encrypted data of the contents into said storage means ends.

59. A time shift outputting apparatus as claimed in claim 56, wherein said master encryption key producing means produces the master encryption key at least part of which varies as time passes.

60. A time shift outputting apparatus as claimed in claim 56, further comprising means for canceling the retention of the random number value retained by said random number retaining means when predetermined time passes after the storage of the encrypted data of the contents into said storage means is started.

61. A time shift outputting apparatus as claimed in claim 56, further comprising means for canceling the retention of the random number value retained by said random number retaining means when predetermined time passes after the storage of the encrypted data of the contents into said storage means ends.

62. A time shift outputting apparatus, comprising:
random number generating means for generating a random number value which varies as time passes;
random number value retaining means for retaining the random number value generated by said random number generating means at an arbitrary timing;
master encryption key producing means for producing a master encryption key which varies as time passes;
master encryption key retaining means for retaining the master encryption key produced by said master encryption key producing means at an arbitrary timing;
means for changing the master encryption key retained by said master encryption key retaining means using the random number value retained by said random number value retaining means to produce an encryption key;
means for encrypting data of contents using the encryption key to produce encrypted data;
means for storing the encrypted data;
readout means for reading out the encrypted data stored in said storage means when predetermined time passes after the encrypted data is stored;
means for changing the master encryption key retained by said master encryption key retaining means using the random number value retained by said random number value retaining means to produce a decryption key;
means for decrypting the encrypted data read out by said readout means using the decryption key; and
means for canceling at least any one of the retentions of the random number value retained by said random number value retaining means and the master encryption key retained by said master encryption key retaining means after the decryption of the encrypted data of the contents ends.

63. A time shift outputting apparatus as claimed in claim 62, further comprising means for canceling the retention of the master encryption key when predetermined time passes after the storage of the encrypted data of the contents into said storage means is started.

64. A time shift outputting apparatus as claimed in claim 62, further comprising means for canceling the retention of the master encryption key when predetermined time passes after the storage of the encrypted data of the contents into said storage means ends.

65. A time shift outputting apparatus as claimed in claim 62, wherein said master encryption key producing means produces the master encryption key at least part of which varies as time passes.

66. A time shift outputting apparatus as claimed in claim 62, further comprising means for canceling the retention of the random number value retained by said random number retaining means when predetermined time passes after the storage of the encrypted data of the contents into said storage means is started.

67. A time shift outputting apparatus as claimed in claim 62, further comprising means for canceling the retention of the random number value retained by said random number retaining means when predetermined time passes after the storage of the encrypted data of the contents into said storage means ends.

68. A time shift outputting apparatus, comprising:
random number generating means for generating a random number value which varies as time passes;
means for changing a master encryption key using the random number value generated by said random number value generating means to produce a work encryption key;
work encryption key retaining means for retaining the work encryption key at an arbitrary timing;
means for encrypting data of contents using the work encryption key retained by said work encryption key retaining means to produce encrypted data;
means for storing the encrypted data;
readout means for reading out the encrypted data stored in said storage means when predetermined time passes after the encrypted data is stored;
means for decrypting the encrypted data read out by said readout means using the work encryption key retained by said work encryption key retaining means; and
means for canceling the retention of the work encryption key after the decryption of the encrypted data of the contents ends.

69. A time shift outputting apparatus as claimed in claim 68, further comprising means for canceling the retention of the work encryption key when predetermined time passes after the storage of the encrypted data of the contents into said storage means is started.

70. A time shift outputting apparatus as claimed in claim 68, further comprising means for canceling the retention of the work encryption key when predetermined time passes after the storage of the encrypted data of the contents into said storage means ends.

71. A time shift outputting apparatus, comprising:
random number generating means for generating a random number value which varies as time passes;
master encryption key producing means for producing a master encryption key which varies as time passes;
means for changing the master encryption key using the random number value generated by said random number value generating means to produce a work encryption key;
work encryption key retaining means for retaining the work encryption key at an arbitrary timing;
means for encrypting data of contents using the work encryption key retained by said work encryption key retaining means to produce encrypted data;
means for storing the encrypted data;
readout means for reading out the encrypted data stored in said storage means when predetermined time passes after the encrypted data is stored;
means for decrypting the encrypted data read out by said readout means using the work encryption key retained by said work encryption key retaining means; and
means for canceling the retention of the work encryption key after the decryption of the encrypted data of the contents ends.

72. A time shift outputting apparatus as claimed in claim 71, wherein said master encryption key producing means produces a master encryption key at least part of which varies as time passes.

73. A time shift outputting apparatus as claimed in claim 71, further comprising means for canceling the retention of the work encryption key when predetermined time passes after the storage of the encrypted data of the contents into said storage means is started.

74. A time shift outputting apparatus as claimed in claim 71, further comprising means for canceling the retention of the work encryption key when predetermined time passes after the storage of the encrypted data of the contents into said storage means ends.
